(19) United States
(12) Patent Application Publication
(10) Pub. No.: US 2025/0259783 A1
(43) Pub. Date: Aug. 14, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Tsuyoshi Takamatsu, Nagaokakyo-shi (JP); Hideki Kamo, Nagaokakyo-shi (JP); Ryouta Sakurai, Nagaokakyo-shi (JP)

(73) Assignee: Murata Manufacturing Co., Ltd., Kyoto-fu (JP)

(21) Appl. No.: 19/195,362

(22) Filed: Apr. 30, 2025

Related U.S. Application Data
(63) Continuation of application No. PCT/JP2023/030260, filed on Aug. 23, 2023.

(30) Foreign Application Priority Data
Nov. 2, 2022 (JP) 2022-176445

(51) Int. Cl. H01F 27/29; H01F 17/00

(52) U.S. Cl. CPC H01F 27/292; H01F 17/0013

(57) ABSTRACT

An inductor component includes an element body having first and second principal surfaces opposite to each other; a coil that has at least a part in the element body and is wound in a spiral shape along an axis; and first and second external electrodes that are outside the element body and are electrically connected to the coil. The axis of the coil is parallel to the first principal surface. The coil includes first coil wirings which are on the first principal surface side with respect to the axis and are arranged along the axis on a plane parallel to the first principal surface, and second coil wirings which are on the second principal surface side with respect to the axis and are arranged along the axis on a plane parallel to the second principal surface.

### CROSS REFERENCE TO RELATED APPLICATION

This application claims benefit of priority to International Patent Application No. PCT/JP2023/030260, filed Aug. 23, 2023, and to Japanese Patent Application 2022-176445, filed Nov. 2, 2022, the entire content of each are incorporated herein by reference.

### BACKGROUND

### Technical Field

The present disclosure relates to an inductor component.

### Background Art

Conventionally, as an inductor component, there is an inductor component described in Japanese Patent No. 6652280. The inductor component includes an element body, a coil that is provided in the element body and is wound along an axial direction, and a first external electrode and a second external electrode that are provided on the element body and are electrically connected to the coil.

The coil has a plurality of coil patterns layered along an axis. The coil patterns adjacent to each other in the axial direction are connected via a conductive via. Each coil pattern includes a wiring portion extending in a direction orthogonal to the axis and a pad portion that is provided at an end portion of the wiring portion and is connected to the conductive via. A width of the pad portion is wider than a width of the wiring portion in order to improve the connectivity between the pad portion and the conductive via.

### SUMMARY

Incidentally, in the conventional inductor component, since the width of the pad portion is wider than the width of the wiring portion, a part of the pad portion is positioned on an inner side in a radial direction of the coil with respect to the wiring portion. Therefore, an inner diameter of the coil becomes small, and the efficiency of acquisition of inductance is not necessarily high.

In this regard, the present disclosure provides an inductor component capable of increasing the efficiency of acquisition of inductance.

Accordingly, one aspect of the present disclosure provides an inductor component comprising an element body having a first principal surface and a second principal surface opposite to each other; a coil that has at least a part provided in the element body and is wound in a spiral shape along an axis; and a first external electrode and a second external electrode that are provided outside the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. The plurality of first coil wirings include an endmost coil wiring provided at an endmost position on one side in the axial direction. The endmost coil wiring has an upper surface positioned on a side in a first direction from the second principal surface side toward the first principal surface side, and a first side surface and a second side surface positioned on both sides sandwiching a center line of the endmost coil wiring in an extending direction thereof when viewed in a direction orthogonal to the first principal surface. The first external electrode includes a first part in contact with at least a part of the first side surface, a second part in contact with at least a part of the upper surface, and a third part in contact with at least a part of the second side surface, and the first part, the second part, and the third part are continuous in this order and form a protrusion protruding toward one side in the first direction.

According to the aspect, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the first external electrode has the protrusion protruding toward the side in the first direction, a surface area is increased as compared with the case of a flat surface without the protrusion, and it is possible to improve the fixing strength with a connection member such as solder. In addition, the protrusion of the first external electrode is in contact with the endmost coil wiring, and the first external electrode and the endmost coil wiring are directly connected to each other. Consequently, it is possible to decrease the direct current resistance (Rdc) as compared with a case where the first external electrode and the endmost coil wiring are connected by, for example, a via wiring or the like.

Preferably, in an embodiment of the inductor component, the first external electrode has a thickness smaller than a thickness of the first coil wirings.

According to the embodiment, it is possible to decrease a thickness of the inductor component.

Preferably, in the embodiment of the inductor component, the element body contains SiO₂.

According to the embodiment, it is possible to impart insulation properties and stiffness to the element body.

Preferably, in the embodiment of the inductor component, the first external electrode includes a plurality of conductive layers including a conductive layer made of a material different from a material of a conductive layer of the endmost coil wiring.

According to the embodiment, it is possible to impart, to the first external electrode, characteristics different from those of the endmost coil wiring.

Preferably, in the embodiment of the inductor component, the first external electrode further includes a bottom portion which is provided continuously from the first part of the protrusion to a side opposite to the second part and extends in a direction parallel to the first principal surface; and a wall portion which is provided continuously from the bottom portion and extends in the first direction.

According to the embodiment, it is possible to further increase the surface area of the first external electrode such that it is possible to further improve, for example, the fixing strength with the connection member such as solder.

Preferably, in the embodiment of the inductor component, the first external electrode further includes a fourth part which is separated from the second part and is positioned closer to the side in the first direction than the second part is.

According to the embodiment, since the first external electrode further includes the fourth part positioned closer to the side in the first direction than the second part is, it is possible to further increase the surface area of the first external electrode, and it is possible to further improve, for example, the fixing strength with the connection member such as solder.

Preferably, in the embodiment of the inductor component, the first principal surface has a recess, the recess has a side surface having a stepped shape, and at least a part of the first external electrode has a shape which is in contact with the side surface and conforms to the side surface.

According to the embodiment, it is possible to further increase the surface area of the first external electrode such that it is possible to further improve, for example, the fixing strength with the connection member such as solder.

Preferably, the embodiment of the inductor component further comprises an insulating body provided on a part of the first principal surface. At least a part of the first external electrode is continuously in contact with the insulating body, the first principal surface, and the first side surface of the protrusion.

According to the embodiment, since it is possible to make the first external electrode have an uneven shape, for example, it is possible to further improve the fixing strength with the connection member such as solder.

Preferably, in the embodiment of the inductor component, the first coil wiring is provided in the first principal surface, the inductor component further comprises an insulating body that covers the first coil wiring and has a shape conforming to a shape of the first coil wiring, and at least a part of the first external electrode is in contact with the insulating body and has a shape conforming to the shape of the first coil wiring.

According to the embodiment, since at least a part of the first external electrode has a shape conforming to the shape of the first coil wirings, it is possible to further increase the surface area of the first external electrode, and it is possible to further improve, for example, the fixing strength with the connection member such as solder.

Preferably, the embodiment of the inductor component, further comprises an organic insulating body provided on the first principal surface. The element body is an inorganic insulating body, and the organic insulating body is positioned on an inner side with respect to an outer surface of the inorganic insulating body when viewed in the direction orthogonal to the first principal surface.

According to the embodiment, since the organic insulating body is provided, the organic insulating body easily imparts flowability, the organic insulating body easily fills a space between the first coil wirings adjacent to each other and enables insulating properties to be improved, in a case where the first coil wirings are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

Preferably, in the embodiment of the inductor component, when viewed in a direction parallel to the axis, the first penetration wirings and the second penetration wirings are not parallel to each other.

According to the embodiment, it is possible to increase a distance between each of the first penetration wirings and each of the second penetration wirings, and it is possible to increase the inner diameter of the coil such that it is possible to increase the Q value.

Preferably, in the embodiment of the inductor component, the element body contains SiO₂, and the first penetration wirings contain SiO₂.

According to the embodiment, the first penetration wirings can have a linear expansion coefficient equal to a linear expansion coefficient of the element body, and it is possible to reduce cracks between the first penetration wirings and the element body.

Preferably, in the embodiment of the inductor component, each of the first penetration wirings has a void portion or a resin portion.

According to the embodiment, stress due to a difference in linear expansion coefficient between the first penetration wirings and the element body can be absorbed by the void portion or the resin portion, and this enables the stress to be alleviated.

Preferably, in the embodiment of the inductor component, each of the first penetration wirings includes a conductive layer positioned on an outer circumferential side when viewed in an extending direction of the first penetration wirings, and a non-conductive layer positioned inside the conductive layer.

According to the embodiment, since a current mainly flows in a surface of the first penetration wirings due to a skin effect in the case of use in a high frequency band, the Q value is not decreased by providing the conductive layer on the outer circumferential side. In addition, by providing the non-conductive layer inside, stress can be alleviated, and manufacturing costs can be reduced by using no conductor.

Preferably, in the embodiment of the inductor component, a length of the coil in an axial direction is shorter than an inner diameter of the coil.

According to the embodiment, since the coil length is short and the inner diameter of the coil is large, it is possible to increase the Q value.

Preferably, in the embodiment of the inductor component, the first penetration wirings extend in the direction orthogonal to the first principal surface, and a cross-sectional area of at least one of both end portions of each of the first penetration wirings in the extending direction is larger than a cross-sectional area of a central portion of each of the first penetration wirings in the extending direction.

According to the embodiment, it is possible to increase the cross-sectional area of the end portion of the first penetration wiring such that connectivity between the first penetration wiring and at least one of the first coil wiring and the second coil wiring can be improved. In addition, when a hole portion is formed in the element body, the hole portion is filled with a conductive material by fill plating or the like, and the first penetration wiring is formed in the hole portion of the element body, it is easy to fill the hole portion on an opening side with the conductive material. Since the cross-sectional area of the end portion of the first penetration wiring is large, and the cross-sectional area of the central portion of the first penetration wiring is small, the first penetration wiring is easily formed.

Preferably, in the embodiment of the inductor component, the coil component has a thickness of 200 μm or smaller.

According to the embodiment, it is possible to decrease a thickness of the inductor component.

Preferably, in the embodiment of the inductor component, when viewed in the direction orthogonal to the first principal surface, the first external electrode and the second external electrode are positioned on an inner side with respect to an outer surface of the element body.

According to the configuration, since the first external electrode and the second external electrode are not in contact with the outer surfaces of the element body, loads applied to the first external electrode and the second external electrode can be decreased, and deformation and peeling of the first external electrode and the second external electrode can be reduced, when division into individual inductor components is performed. Therefore, even if the inductor component has a small size, it is possible to prevent the first external electrode and the second external electrode from being deformed or peeled off.

According to the inductor component which is the one aspect of the present disclosure, it is possible to increase the efficiency of acquisition of inductance.

### BRIEF DESCRIPTION OF THE DRAWINGS

FIG. 1 is a schematic bottom view of an inductor component from a bottom surface side according to a first embodiment;

FIG. 2 is a cross-sectional view taken along line II-II in FIG. 1;

FIG. 3 is a cross-sectional view taken along line III-III in FIG. 1;

FIG. 4 is an enlarged view of portion A of FIG. 3;

FIG. 5A is a schematic cross-sectional view illustrating a method for manufacturing an inductor component;

FIG. 5B is a schematic cross-sectional view illustrating the method for manufacturing an inductor component;

FIG. 5C is a schematic cross-sectional view illustrating the method for manufacturing an inductor component;

FIG. 5D is a schematic cross-sectional view for illustrating the method for manufacturing an inductor component;

FIG. 5E is a schematic cross-sectional view illustrating the method for manufacturing an inductor component;

FIG. 5F is a schematic cross-sectional view illustrating the method for manufacturing an inductor component;

FIG. 5G is a schematic cross-sectional view illustrating the method for manufacturing an inductor component;

FIG. 5H is a schematic cross-sectional view illustrating the method for manufacturing an inductor component;

FIG. 5I is a schematic cross-sectional view illustrating the method for manufacturing an inductor component;

FIG. 5J is a schematic cross-sectional view illustrating the method for manufacturing an inductor component;

FIG. 5K is a schematic cross-sectional view illustrating the method for manufacturing an inductor component;

FIG. 5L is a schematic cross-sectional view illustrating the method for manufacturing an inductor component;

FIG. 5M is a schematic cross-sectional view illustrating the method for manufacturing an inductor component;

FIG. 5N is a schematic cross-sectional view illustrating the method for manufacturing an inductor component;

FIG. 5O is a schematic cross-sectional view illustrating the method for manufacturing the inductor component;

FIG. 6A is a cross-sectional view showing a first modification example of the inductor component;

FIG. 6B is a cross-sectional view showing a second modification example of the inductor component;

FIG. 6C is a cross-sectional view showing a third modification example of the inductor component;

FIG. 6D is a cross-sectional view showing a fourth modification example of the inductor component;

FIG. 6E is a cross-sectional view showing a fifth modification example of the inductor component;

FIG. 7 is a schematic bottom view of an inductor component from a bottom surface side according to a second embodiment;

FIG. 8 is a cross-sectional view taken along line VIII-VIII in FIG. 7;

FIG. 9 is an enlarged view of portion A of FIG. 8;

FIG. 10A is a schematic cross-sectional view illustrating a method for manufacturing an inductor component;

FIG. 10B is a schematic cross-sectional view illustrating the method for manufacturing an inductor component;

FIG. 10C is a schematic cross-sectional view illustrating the method for manufacturing an inductor component;

FIG. 10D is a schematic cross-sectional view illustrating the method for manufacturing an inductor component;

FIG. 10E is a schematic cross-sectional view illustrating the method for manufacturing an inductor component;

FIG. 10F is a schematic cross-sectional view illustrating the method for manufacturing an inductor component;

FIG. 10G is a schematic cross-sectional view illustrating the method for manufacturing an inductor component;

FIG. 10H is a schematic cross-sectional view illustrating the method for manufacturing an inductor component;

FIG. 11A is a schematic cross-sectional view showing a first modification example of the inductor component;

FIG. 11B is a schematic cross-sectional view showing a second modification example of the inductor component; and

FIG. 11C is a schematic cross-sectional view showing a third modification example of the inductor component.

### DETAILED DESCRIPTION

Hereinafter, an inductor component which is the one aspect of the present disclosure will be described in detail with reference to embodiments shown in the drawings. Note that the drawings include some schematic drawings, and may not reflect actual dimensions and ratios.

### First Embodiment

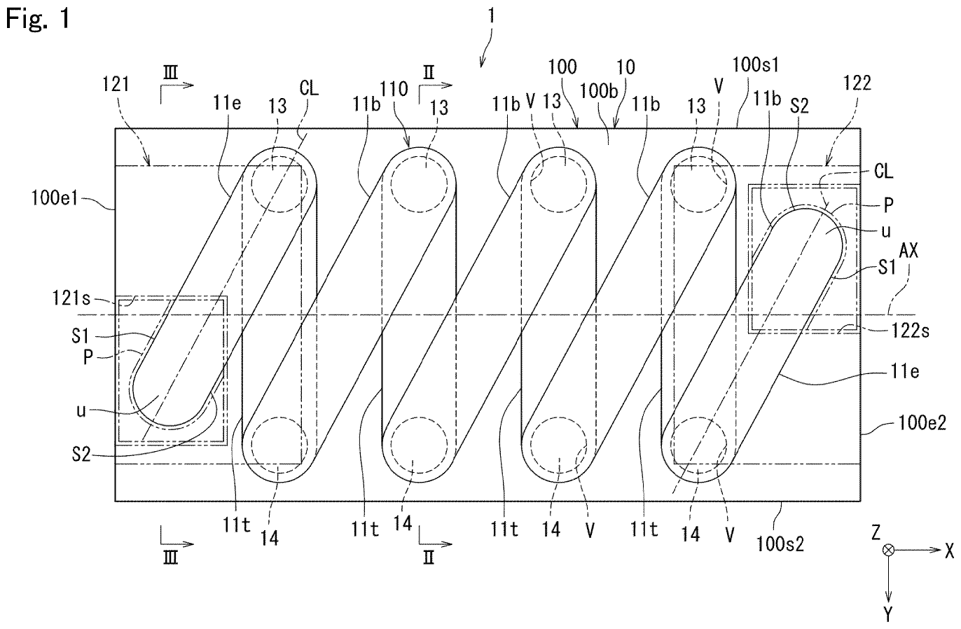

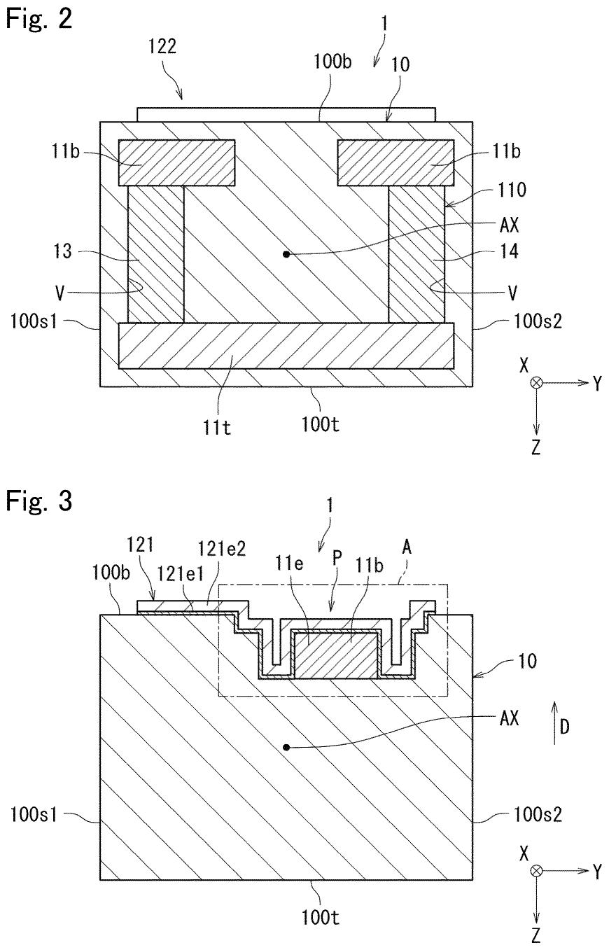

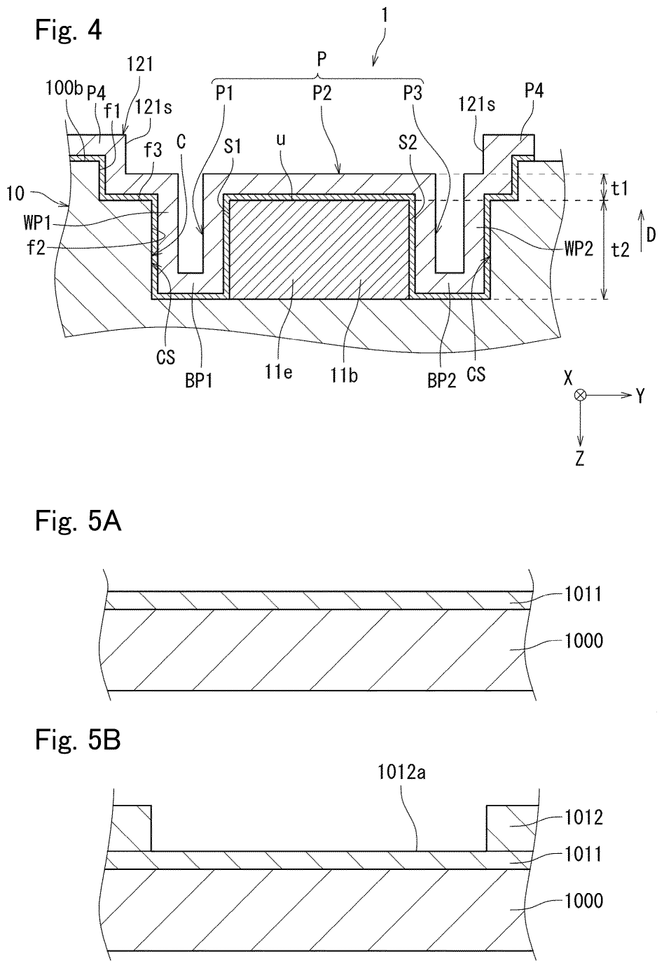

An inductor component 1 according to the first embodiment will be described below. FIG. 1 shows a schematic bottom view of the inductor component 1 from a bottom surface side thereof. FIG. 2 is a cross-sectional view taken along line II-II in FIG. 1. FIG. 3 is a cross-sectional view taken along line III-III in FIG. 1. FIG. 4 is an enlarged view of portion A of FIG. 3. Note that, in FIG. 1, an external electrode is drawn by a two-dot chain line for convenience. In addition, in FIG. 1, an element body 10 is drawn transparently so that a structure thereof can be easily understood, but may be translucent or opaque.

### 1. General Configuration

A general configuration of the inductor component 1 will be described. The inductor component 1 is, for example, a surface mount inductor component that is used in a high-frequency signal transmission circuit. As shown in FIGS. 1 to 4, the inductor component 1 includes the element body 10, a coil 110 that has at least a part provided in the element body 10 and is wound in a spiral shape along an axis AX, and a first external electrode 121 and a second external electrode 122 that are provided outside the element body 10 and are electrically connected to the coil 110.

The element body 10 has a length, a width, and a height. The element body 10 has a first end surface 100e1 and a second end surface 100e2 on both end sides in a length direction, a first side surface 100s1 and a second side surface 100s2 on both end sides in a width direction, and a bottom surface 100b and a top surface 100t on both end sides in a height direction. That is, outer surfaces 100 of the element body 10 include the first end surface 100e1 and the second end surface 100e2, the first side surface 100s1 and the second side surface 100s2, and the bottom surface 100b and the top surface 100t. The bottom surface 100b corresponds to an example of a “first principal surface” described in CLAIMS, and the top surface 100t corresponds to an example of a “second principal surface” described in CLAIMS.

As shown in the drawings, hereinafter, for convenience of description, the length direction (longitudinal direction) of the element body 10 is defined as an X direction. A direction from the first end surface 100e1 toward the second end surface 100e2 is defined as a forward X direction, and a direction opposite to the forward X direction is defined as a reverse X direction. In addition, a width direction of the element body 10 is defined as a Y direction. A direction from the first side surface 100s1 toward the second side surface 100s2 is defined as a forward Y direction, and a direction opposite to the forward Y direction is defined as a reverse Y direction. In addition, a height direction of the element body 10 is defined as a Z direction. A direction from the bottom surface 100b toward the top surface 100t is defined as a forward Z direction, and a direction opposite to the forward Z direction is defined as a reverse Z direction. The X direction, the Y direction, and the Z direction are directions orthogonal to each other and form a right-handed system when arranged in an order of X, Y, and Z. In this specification, a direction from the top surface 100t side toward the bottom surface 100b side is referred to as a first direction D1. The first direction D1 includes not only a direction parallel to the Z direction but also a direction inclined from a direction parallel to the Z direction. In this embodiment, the first direction D1 is the reverse Z direction.

In this specification, the “outer surfaces 100 of the element body” including the first end surface 100e1, the second end surface 100e2, the first side surface 100s1, the second side surface 100s2, the bottom surface 100b, and the top surface 100t of the element body 10 do not simply mean surfaces of the element body 10 toward the outer circumferential sides of the element body 10, but are surfaces serving as a boundary between an outside and an inside of the element body 10. In addition, “above the outer surfaces 100 of the element body 10” does not indicate an absolute direction such as a vertical upward direction defined in the direction of gravity, but indicates a direction toward the outside with the outer surfaces 100 as a reference, of the outside and inside with the outer surfaces 100 as the boundary therebetween. Hence, “above the outer surfaces 100” indicates a relative direction determined depending on an orientation of the outer surfaces 100. In addition, “above” with respect to a certain element means not only above from the corresponding element, that is, an upper position via another object on the corresponding element or an upper position apart from the corresponding element at an interval, but also a position immediately on the corresponding element to be in contact with the corresponding element.

The axis AX of the coil 110 is disposed parallel to the bottom surface 100b. The coil 110 includes a plurality of bottom surface wirings 11b which are provided on the bottom surface 100b side with respect to the axis AX and are arranged along the axis AX on a plane parallel to the bottom surface 100b, a plurality of top surface wirings 11t which are provided on the top surface 100t side with respect to the axis AX and are arranged along the axis AX on a plane parallel to the top surface 100t, a plurality of first penetration wirings 13 which extend from the respective bottom surface wirings 11b toward the respective top surface wirings 11t, and are arranged along the axis AX, and a plurality of second penetration wirings 14 which extend from the respective bottom surface wirings 11b toward the respective top surface wirings 11t, are provided on a side opposite to the respective first penetration wirings 13 with respect to the axis AX, and are arranged along the axis AX. The plurality of bottom surface wirings 11b include an endmost coil wiring 11e positioned on one side in the axis AX direction. In this embodiment, of the plurality of bottom surface wirings 11b, both the two bottom surface wirings 11b positioned at both ends in the axis AX direction are the endmost coil wirings 11e. Each of the bottom surface wirings 11b, each of the first penetration wirings 13, each of the top surface wirings 11t, and each of the second penetration wirings 14 form at least a part of a spiral shape by being connected in this order.

The bottom surface wiring 11b corresponds to an example of a “first coil wiring” described in CLAIMS, and the top surface wiring 11t corresponds to an example of a “second coil wiring” described in CLAIMS. The axis AX indicates an intersection line of a first plane passing through centers between the bottom surface wirings 11b and the top surface wirings 11t and a second plane passing through centers between the first penetration wirings 13 and the second penetration wirings 14. That is, the axis AX is a straight line passing through a center of an inner diameter portion of the coil 110. The axis AX of the coil 110 does not have a dimension in a direction orthogonal to the axis AX.

According to the configuration described above, since the coil 110 includes the bottom surface wirings 11b, the first penetration wirings 13, the top surface wirings 11t, and the second penetration wirings 14, and each of the bottom surface wirings 11b, each of the first penetration wirings 13, each of the top surface wirings 11t, and each of the second penetration wirings 14 form at least a part of the spiral shape by being connected in this order, it is possible to increase an inner diameter of the coil 110 such that it is possible to increase the efficiency of acquisition of inductance. In addition, a Q value can be increased by increasing the efficiency of acquisition of inductance.

To be more specific, since pad portions of a conventional inductor component or the bottom surface wirings 11b and the top surface wirings 11t of the present embodiment are “reception portions” of wirings (conductive vias of the conventional inductor component or the first penetration wirings 13 and the second penetration wirings 14 of the present embodiment) which penetrate an element body, the pad portions and the bottom and top surface wirings have a shape expanding perpendicularly to a direction in which to penetrate the element body. Here, in a configuration of the conventional inductor component, since the conductive vias extend in a direction parallel to an axis of a coil, the pad portions are expanded in a direction perpendicular to the axis of the coil and are likely to have a structure in which magnetic flux generated in an axial direction of the coil is blocked.

On the other hand, in the present embodiment, since the first penetration wiring 13 and the second penetration wiring 14 extend in a direction perpendicular to the axis AX of the coil 110, the bottom surface wiring 11b and the top surface wiring 11t are expanded in a direction parallel to the axis AX of the coil 110. Accordingly, it is difficult for the bottom surface wiring 11b and the top surface wiring 11t to have a structure in which magnetic flux generated in an axis AX direction is blocked. That is, according to the present embodiment, it is possible to have the structure in which it is difficult to block the magnetic flux such that it is possible to improve the efficiency of acquisition of inductance and the Q value.

As shown in FIGS. 1 and 4, the endmost coil wiring 11e positioned on the first end surface 100e1 side with respect to the center of the element body 10 in the X direction has an upper surface u positioned on a side in the first direction D1, and a first side surface S1 and a second side surface S2 positioned on both sides sandwiching a center line CL of the endmost coil wiring 11e in an extending direction thereof when viewed in a direction (Z direction) orthogonal to the bottom surface 100b. The first external electrode 121 includes a first part P1 in contact with at least a part of the first side surface S1 of the endmost coil wiring 11e, a second part P2 in contact with at least a part of the upper surface u of the endmost coil wiring 11e, and a third part P3 in contact with at least a part of the second side surface S2 of the endmost coil wiring 11e. The first part P1, the second part P2, and the third part P3 are continuous in this order and form a protrusion P protruding toward the side in the first direction D1.

Similarly, the endmost coil wiring 11e positioned on the second end surface 100e2 side with respect to the center of the element body 10 in the X direction has an upper surface u positioned on a side in the first direction D1, and a first side surface S1 and a second side surface S2 positioned on both sides sandwiching a center line CL of the endmost coil wiring 11e in an extending direction thereof when viewed in the direction (Z direction) orthogonal to the bottom surface 100b. The second external electrode 122 includes a first part in contact with at least a part of the first side surface S1 of the endmost coil wiring 11e, a second part in contact with at least a part of the upper surface u of the endmost coil wiring 11e, and a third part in contact with at least a part of the second side surface S2 of the endmost coil wiring 11e. The first part, the second part, and the third part are continuous in this order and form a protrusion P protruding toward the side in the first direction D1.

According to the configuration described above, since the first external electrode 121 and the second external electrode 122 have the respective protrusions P protruding toward the side in the first direction D1, a surface area is increased as compared with the case of a flat surface without the protrusion P, and it is possible to improve the fixing strength with a connection member such as solder. In addition, the protrusions P of the first external electrode 121 and the second external electrode 122 are in contact with the respective endmost coil wirings 11e, and both the first external electrode 121 and the second external electrode 122 and the respective endmost coil wirings 11e are directly connected to each other. Consequently, it is possible to decrease the direct current resistance (Rdc) as compared with a case where both the first external electrode 121 and the second external electrode 122 and the endmost coil wirings 11e are connected by, for example, via wirings or the like, respectively.

### 2. Configurations of Respective Units

### (Inductor Component 1)

A volume of the inductor component 1 is preferably 0.08 mm³ or smaller, and a size of a long side of the inductor component 1 is 0.65 mm or smaller. The size of the long side of the inductor component 1 indicates the largest value of a length, a width, and a height of the inductor component 1, and in this embodiment, indicates the length in the X direction. According to the configuration described above, since the volume of the inductor component 1 is small and the long side of the inductor component 1 is short, a weight of the inductor component 1 is reduced. Therefore, even if the external electrodes 121 and 122 are small, necessary mounting strength can be obtained. In addition, a thickness of the inductor component 1 is preferably 200 μm or smaller. This enables a thin inductor component 1 to be obtained.

To be more specific, the size (length (X direction)×width (Y direction)×height (Z direction)) of the inductor component 1 is 0.6 mm×0.3 mm×0.3 mm, 0.4 mm×0.2 mm×0.2 mm, 0.25 mm×0.125 mm×0.120 mm, or the like. In addition, the width and the height may not be equal, and may be, for example, 0.4 mm×0.2 mm×0.3 mm.

### (Element Body 10)

Preferably, the element body 10 contains SiO₂. This enables insulation properties and stiffness to be imparted to the element body 10. The element body 10 is made of, for example, a glass sintered body. The glass sintered body may contain alumina, and the strength of the element body can be further increased.

The glass sintered body is formed by, for example, layering insulating layers containing a plurality of types of glass. A layering direction of the plurality of insulating layers is the Z direction. That is, the insulating layer has a layer shape having a principal surface expanding on an X-Y plane. Note that, in the element body 10, an interface between the plurality of insulating layers may not be distinct due to firing or the like.

Note that the element body 10 may include, for example, a glass substrate. The glass substrate may be a single-layer glass substrate, and since most of the element body is made of glass, it is possible to reduce a loss such as an eddy current loss at a high frequency.

As shown in FIG. 4, the bottom surface 100b of the element body 10 has a recess C. To be more specific, the recess C is provided such that a connection part of each of the two endmost coil wirings 11e with the first external electrode 121 or the second external electrode 122 is exposed from the element body 10. A shape of the recess C when viewed in the Z direction is not particularly limited as long as the connection part is exposed from the element body 10, but in this embodiment, the recess C is formed in a rectangular shape.

### (Coil 110)

The coil 110 includes the plurality of bottom surface wirings 11b, the plurality of top surface wirings 11t, the plurality of first penetration wirings 13, and the plurality of second penetration wirings 14. The bottom surface wirings 11b, the first penetration wirings 13, the top surface wirings 11t, and the second penetration wirings 14 are connected in this order, respectively, to constitute at least a part of the coil 110 wound in the axis AX direction.

According to the configuration described above, since the coil 110 is a so-called helical coil 110, in a cross section orthogonal to the axis AX, it is possible to reduce a region where the bottom surface wiring 11b, the top surface wiring 11t, the first penetration wiring 13, and the second penetration wiring 14 are laid out parallel to each other in a winding direction of the coil 110, and it is possible to reduce stray capacitance in the coil 110.

Here, the helical shape indicates a shape in which the number of turns of the entire coil is more than one turn, and the number of turns of the coil in the cross section orthogonal to the axis is less than one turn. One or more turns indicate a state in which the wirings of the coil have, on the cross section orthogonal to the axis, parts that are adjacent to each other in a radial direction and are laid out parallel to each other in the winding direction when viewed in an axial direction, and less than one turn indicates a state in which the wirings of the coil does not have, on the cross section orthogonal to the axis, parts that are adjacent to each other in the radial direction and are laid out parallel to each other in the winding direction when viewed in the axial direction.

The bottom surface wirings 11b extend only in one direction. To be more specific, the bottom surface wirings 11b slightly tilt in the X direction and extend in the Y direction. The plurality of bottom surface wirings 11b are arranged parallel to each other in the X direction. Here, in a photolithography process, when deformed illumination such as annular illumination or dipole illumination is used, pattern resolution in a specific direction can be enhanced to form a finer pattern. According to the configuration described above, since the bottom surface wirings 11b extend only in one direction, it is possible to form the fine bottom surface wirings 11b and reduce the size of the inductor component 1 by using, for example, modified illumination in the photolithography process.

As described above, the plurality of bottom surface wirings 11b include the endmost coil wiring 11e provided at an endmost position on one side in the axis AX direction. In this embodiment, an end portion (in other words, the connection part with the first external electrode 121 or the second external electrode 122.) of the endmost coil wiring 11e on one side in the extending direction is disposed in the recess C provided in the bottom surface 100b of the element body 10 and is exposed from the element body 10. To be more specific, of both end portions of the endmost coil wiring 11e in the extending direction, an end portion on one side on which the endmost coil wiring is connected to the first external electrode 121 or the second external electrode 122 is disposed in the recess C and is exposed from the element body 10. Note that the entire endmost coil wiring 11e may be disposed in the recess C and exposed from the element body 10. In this case, the first external electrode 121 or the second external electrode 122 is preferably in contact with an entire exposed surface of the endmost coil wiring 11e (in other words, the entire first side surface s1, the entire second side surface s2, and the entire upper surface u).

The top surface wirings 11t extend only in one direction. To be more specific, the top surface wirings 11t have a shape extending in the Y direction. The plurality of top surface wirings 11t are arranged parallel to each other in the X direction. According to the configuration described above, since the top surface wirings 11t extend only in one direction, it is possible to form the fine narrow top surface wirings 11t and reduce the size of the inductor component 1 by using, for example, modified illumination in the photolithography process.

The bottom surface wirings 11b and the top surface wirings 11t are made of a good conductor material such as copper, silver, gold, or an alloy thereof. The bottom surface wirings 11b and the top surface wirings 11t may be a metal film formed by plating, vapor deposition, sputtering, or the like, or may be a metal sintered body obtained by applying and sintering a conductor paste. In addition, the bottom surface wirings 11b and the top surface wirings 11t may have a multilayer structure in which a plurality of metal layers are layered. The bottom surface wirings 11b and the top surface wirings 11t have a thickness of preferably 5 μm or more and 50 μm or less (i.e., from 5 μm to 50 μm).

The first penetration wirings 13 are disposed in through-holes V of the element body 10 on the first side surface 100s1 side with respect to the axis AX, and the second penetration wirings 14 are disposed in the other through-holes V of the element body 10 on the second side surface 100s2 side with respect to the axis AX. Each of the first penetration wirings 13 and the second penetration wirings 14 extends in a direction orthogonal to the bottom surface 100b and the top surface 100t. This enables lengths of the first penetration wirings 13 and the second penetration wirings 14 to be shortened, thus enabling the direct current resistance (Rdc) to be reduced. The plurality of first penetration wirings 13 and the plurality of second penetration wirings 14 are all arranged parallel to each other in the X direction.

Preferably, the first penetration wirings 13 contain SiO₂. This enables a linear expansion coefficient of the first penetration wiring 13 to be equal to a linear expansion coefficient of the element body 10 in a case where the element body 10 contains SiO₂, thus enabling cracks between the first penetration wirings 13 and the element body 10 to be reduced. The first penetration wiring 13 is made of, for example, a conductive paste. A conductive material is Ag, Cu, or the like. Similarly, the second penetration wirings 14 preferably contain SiO₂.

Preferably, at least one wiring of the bottom surface wirings 11b, the top surface wirings 11t, the first penetration wirings 13, and the second penetration wirings 14 includes a void portion or a resin portion. This enables stress due to a difference in linear expansion coefficient between the wiring and the element body 10 to be absorbed by the void portion or the resin portion, thus enabling the stress to be alleviated. As a method of forming the void portion, for example, the void portion can be formed by sintering a wiring, by using a member which is burned into the material of the wiring by being sintered. As a method for forming the resin portion, for example, the resin portion can be formed by using a conductive paste in the material of the wiring.

Preferably, at least one wiring of the bottom surface wirings 11b and the top surface wirings 11t contains SiO₂. This enables a linear expansion coefficient of the wiring to be equal to the linear expansion coefficient of the element body 10 in a case where the element body 10 contains SiO₂, thus enabling cracks between the wiring and the element body 10 to be reduced.

### (External Electrodes 121 and 122)

The first external electrode 121 is connected to the first end portion of the coil 110, and the second external electrode 122 is connected to the second end portion of the coil 110. The first external electrode 121 is provided on the first end surface 100e1 side with respect to a center of the element body 10 in the X direction to be exposed from the outer surface 100 of the element body 10. The second external electrode 122 is provided on the second end surface 100e2 side with respect to a center of the element body 10 in the X direction to be exposed from the outer surface 100 of the element body 10. As in this embodiment, in a case where the recess C is provided in the bottom surface 100b of the element body 10, the outer surface 100 of the element body 10 includes inner surfaces of the recess C. In addition, in this specification, in the case of using the term “outside the element body”, “outside” includes a region on an inner side of the recess C. That is, the region on the inner side of the recess C is included in the outside of the element body 10.

Note that the first external electrode 121 may be provided to be continuously connected to the bottom surface 100b and the first end surface 100e1. This enables a solder fillet to be formed on the first external electrode 121 when the inductor component 1 is mounted on a mounting substrate, since the first external electrode 121 is a so-called L-shaped electrode. Similarly, the second external electrode 122 may be provided to be continuously connected to the bottom surface 100b and the second end surface 100e2.

The first external electrode 121 has abase layer 121e1 and a plating layer 121e2 covering the base layer 121e1. The base layer 121e1 contains, for example, a conductive material such as Cu, Ni, Ti, or a combination thereof. The plating layer 121e2 contains, for example, a conductive material such as Ni or Au. Similarly, the second external electrode 122 has a base layer and a plating layer covering the base layer. Note that the first external electrode 121 and the second external electrode 122 may be made of a single-layer conductor material.

The first external electrode 121 is provided to cover the entire recess C provided in the bottom surface 100b of the element body 10 when viewed in the Z direction. Consequently, the first external electrode 121 is in contact with an entire surface as a part of the first side surface S1 of the endmost coil wiring 11e which is exposed from the element body 10, is in contact with an entire surface as a part of the upper surface u of the endmost coil wiring 11e which is exposed from the element body 10, and is in contact with an entire surface as a part the second side surface S2 of the endmost coil wiring 11e which is exposed from the element body 10. As a result, the first external electrode 121 has the protrusion P at a position corresponding to the part of the endmost coil wiring 11e which is exposed from the element body 10. The first external electrode 121 has a step 121s corresponding to a step (a first surface to be described below) of the recess C.

Similarly, the second external electrode 122 is provided to cover the entire recess C provided in the bottom surface 100b of the element body 10 when viewed in the Z direction. Consequently, the second external electrode 122 is in contact with an entire surface as a part of the first side surface S1 of the endmost coil wiring 11e which is exposed from the element body 10, is in contact with an entire surface as a part of the upper surface u of the endmost coil wiring 11e which is exposed from the element body 10, and is in contact with an entire surface as a part the second side surface S2 of the endmost coil wiring 11e which is exposed from the element body 10. As a result, the second external electrode 122 has the protrusion P at a position corresponding to the part of the endmost coil wiring 11e which is exposed from the element body 10. The second external electrode 122 has a step 122s corresponding to a step of the recess C.

### (Other Preferred Configurations)

Preferably, as shown in FIG. 4, a thickness t1 of the first external electrode 121 in the Z direction is smaller than a thickness t2 of the bottom surface wiring 11b in the Z direction. Here, in a case where the first external electrode 121 includes a plurality of layers, the thickness of the first external electrode 121 indicates thicknesses of all the layers Even when the thickness of the first external electrode 121 is decreased, the DC resistance (Rdc) is not significantly affected. Therefore, according to the configuration described above, it is possible to decrease the thickness of the inductor component 1 while reducing an increase in the DC resistance. More preferably, the thickness t1 of the first external electrode 121 is ½ or less of the thickness t2 of the bottom surface wiring 11b. Consequently, it is possible to more effectively decrease the thickness of the inductor component 1. Similarly, the thickness of the second external electrode 122 may also be smaller than the thickness of the bottom surface wiring 11b.

Preferably, the first external electrode 121 includes a plurality of conductive layers including a conductive layer made of a material different from a material of a conductive layer of the endmost coil wiring 11e. To be more specific, for example, a conductive layer made of a material having high conductivity such as Cu or Ag may be employed in the endmost coil wiring 11e. In the first external electrode 121, for example, a conductive layer which is made of Ti or the like and has good adhesion with the endmost coil wiring 11e, a conductive layer made of Ni or the like having high electromigration resistance, a conductive layer made of Au or the like having high corrosion resistance, a conductive layer having high solder wettability, or the like may be employed. According to the configuration described above, it is possible to impart, to the first external electrode 121, characteristics different from those of the endmost coil wiring 11e. Similarly, the second external electrode 122 may include a plurality of conductive layers including a conductive layer made of a material different from a material of a conductive layer of the endmost coil wiring 11e.

Preferably, the first external electrode 121 further includes a bottom portion BP1 which is provided continuously from the first part P1 of the protrusion P to a side opposite to the second part P2 and extends in a direction (Y direction) parallel to the bottom surface 100b, and a wall portion WP1 which is provided continuously from the bottom portion BP1 and extends in the first direction D1. According to this configuration, it is possible to further increase the surface area of the first external electrode 121 such that it is possible to further improve, for example, the fixing strength with the connection member such as solder. In addition, preferably, the first external electrode 121 further includes a bottom portion BP2 which is provided continuously from the third part P3 of the protrusion P to the side opposite to the second part P2 and extends in the direction parallel to the bottom surface 100b, and a wall portion WP2 which is provided continuously from the bottom portion BP2 and extends in the first direction D1. According to this configuration, it is possible to further increase the surface area of the first external electrode 121 such that it is possible to further improve, for example, the fixing strength with the connection member such as solder. Similarly, the second external electrode 122 may further include a bottom portion which is provided continuously from at least one of the first part and the third part of the protrusion P to the side opposite to the second part and extends in the direction parallel to the bottom surface 100b, and a wall portion which is provided continuously from the bottom portion and extends in the first direction D1.

Preferably, the first external electrode 121 further includes a fourth part P4 which is separated from the second part P2 and is positioned on a side in the first direction D1 from the second part P2. To be more specific, the fourth part P4 is a part of the first external electrode 121 provided on the bottom surface 100b excluding the recess C. According to this configuration, since the first external electrode 121 further includes the fourth part P4, it is possible to further increase the surface area of the first external electrode 121. In addition, since the fourth part P4 is further included, a shape of the first external electrode 121 between the second part P2 and the fourth part P4 can be a recessed shape. Further, since the fourth part P4 is positioned closer to the side in the first direction D1 side than the second part P2 is, a depth of the recessed shape can be deeper than that in a case where the fourth part P4 is positioned closer to an opposite side in the first direction D1 (a side in the forward Z direction) than the second part P2 is. As a result, it is possible to more effectively increase the surface area of the first external electrode 121 such that it is possible to further improve, for example, the fixing strength with the connection member such as solder. Similarly, the second external electrode 122 may further include a fourth part which is separated from the second part and is positioned on a side in the first direction D1 from the second portion.

Preferably, the bottom surface 100b has the recess C, the recess C has a side surface CS having a stepped shape, and at least a part of the first external electrode 121 has a shape which is in contact with the side surface CS and conforms to the side surface CS. To be more specific, the side surface CS has a first surface f1 extending in the Z direction, a second surface f2 extending in the Z direction, and a third surface f3 that connects the first surface f1 and the second surface f2 to each other and extends along an XYplane. The first surface f1 is disposed on an opening side of the recess C, and the second surface f2 is disposed on the bottom surface side of the recess C. A width of the first surface f1 in the Y direction is larger than a width of the second surface f2 in the Y direction. A width of the first surface f1 in the X direction is larger than a width of the second surface f2 in the X direction. The first surface f1, the second surface f2, and the third surface f3 form a stepped shape of the side surface CS. The number of steps of the stepped shape is not particularly limited. According to the configuration described above, it is possible to further increase the surface area of the first external electrode 121 such that it is possible to further improve, for example, the fixing strength with the connection member such as solder. Similarly, at least a part of the second external electrode 122 may be in contact with the side surface having the stepped shape of the recess C and have a shape conforming to the side surface.

### (Method for Manufacturing Inductor Component 1)

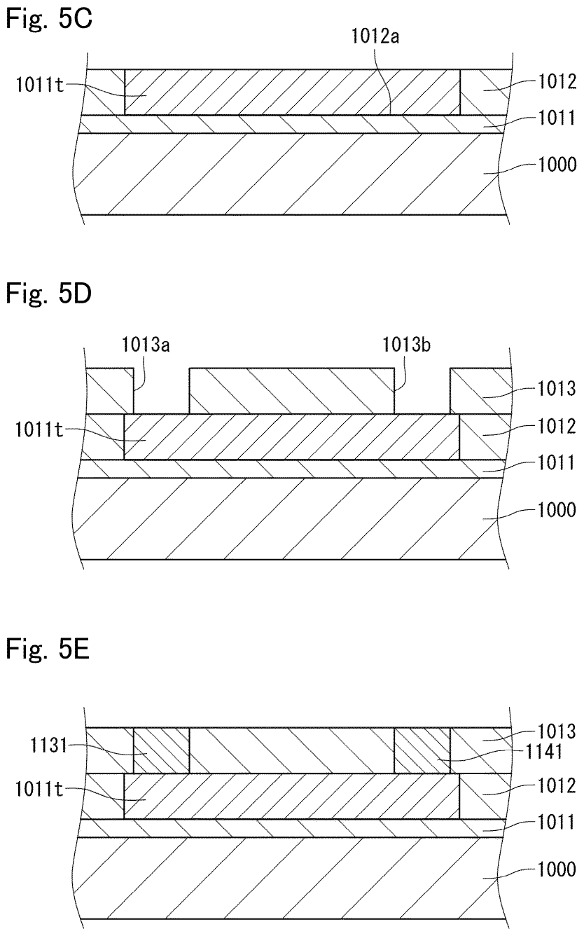

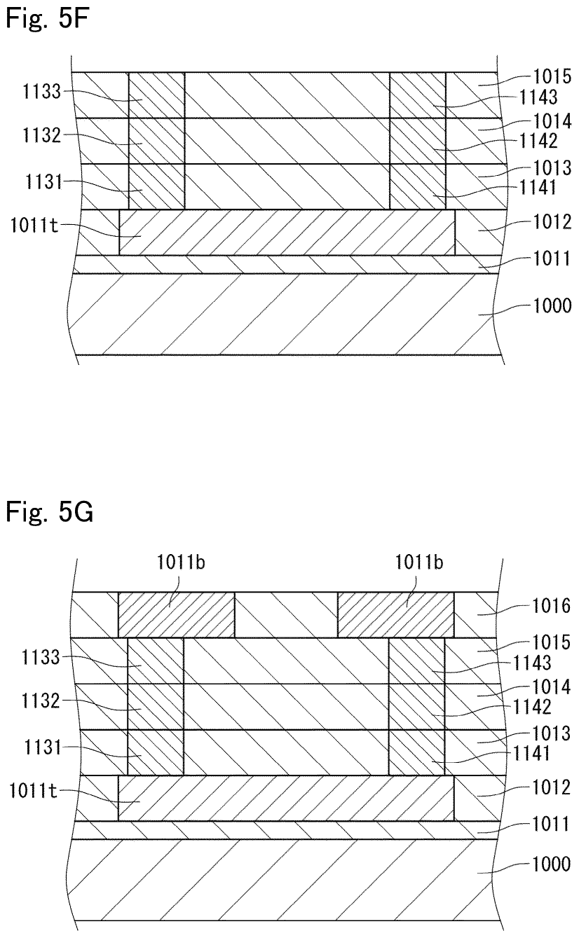

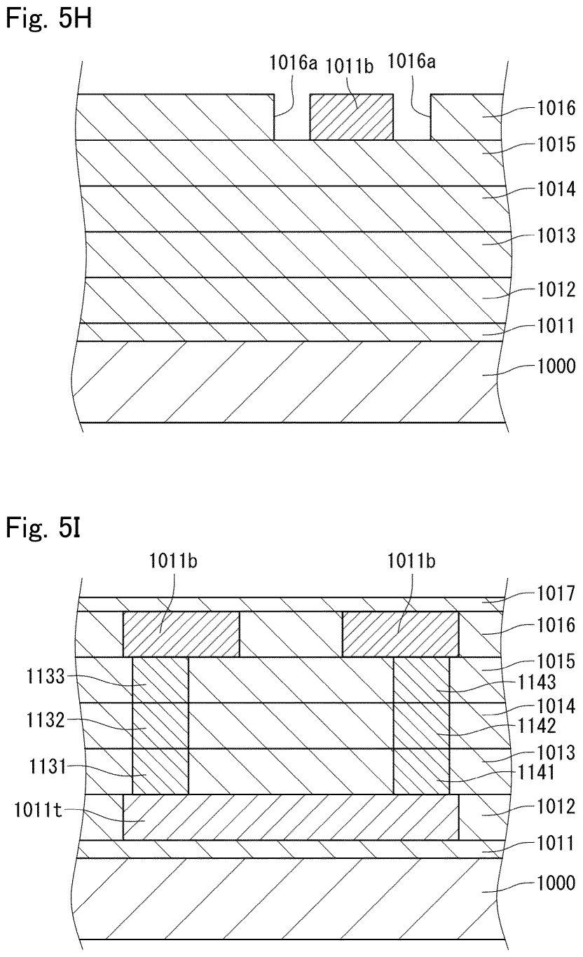

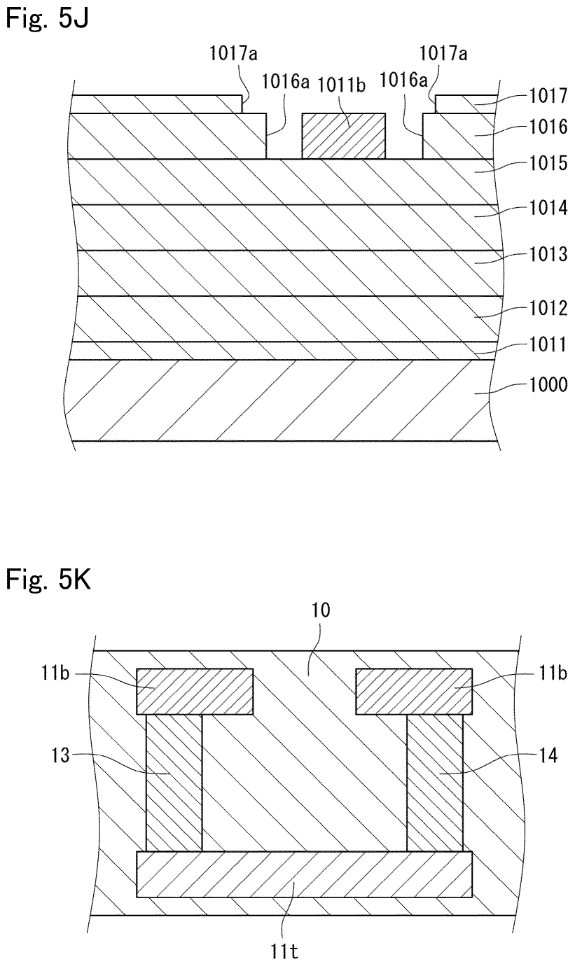

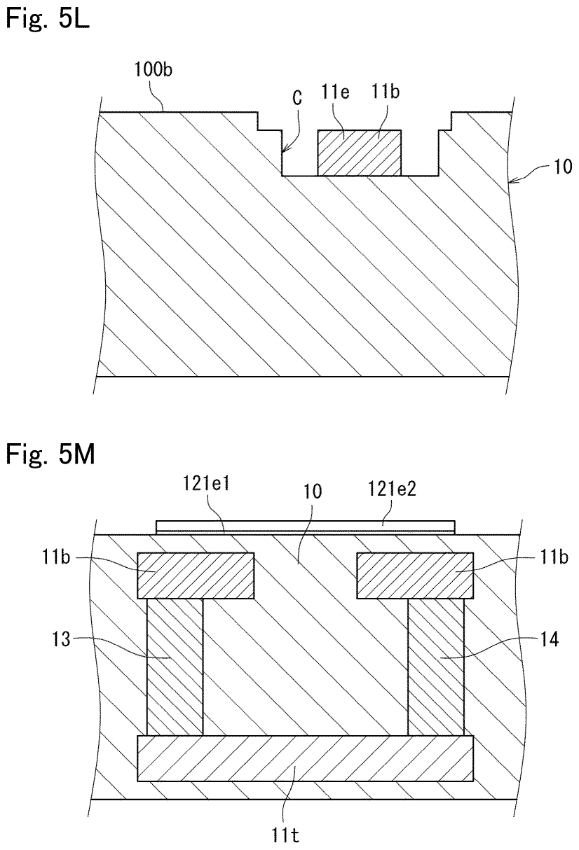

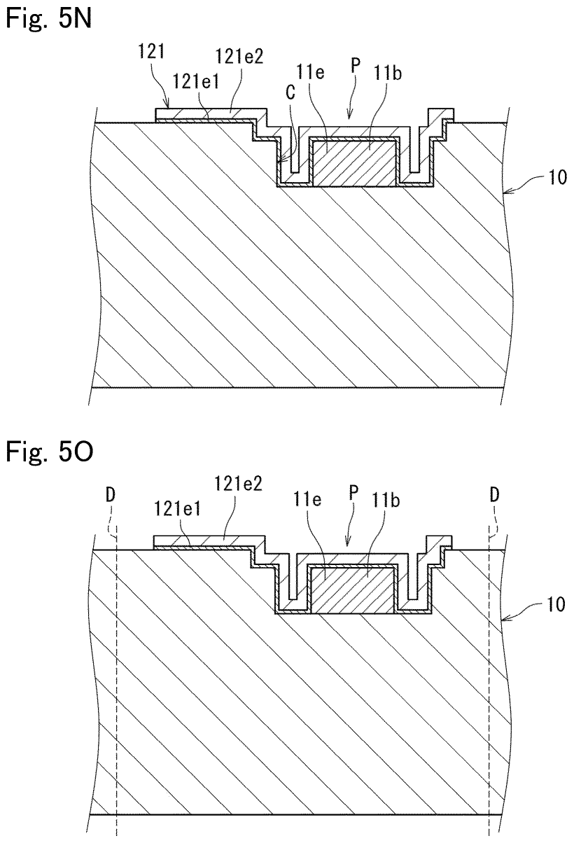

Next, a method for manufacturing the inductor component 1 will be described with reference to FIGS. 5A to 5O. FIGS. 5A to 5G, 5I, 5K, and 5M are views corresponding to a cross section taken along line II-II in FIG. 1. FIGS. 5H, 5J, 5L, 5N, and 5O are views corresponding to a cross section taken along line III-III in FIG. 1.

As shown in FIG. 5A, a first insulating layer 1011 is printed on a base substrate 1000. Examples of materials of the base substrate 1000 include a glass substrate, a silicon substrate, an alumina substrate, or the like, and examples of materials of the first insulating layer 1011 include a resin such as epoxy or polyimide, or an inorganic insulating film such as SiO or SiN.

As shown in FIG. 5B, a second insulating layer 1012 is printed on the first insulating layer 1011. A groove 1012a is provided in the second insulating layer 1012. In this case, for example, the groove 1012a is formed by the photolithography process. Note that the groove may be formed as a printed pattern from the beginning.

As shown in FIG. 5C, atop surface conductor layer 1011t is printed in the groove 1012a. Examples of materials of the top surface conductor layer 1011t include Ag, Cu, Au, Al, an alloy containing at least one of these elements, or a solder paste. In this case, for example, the top surface conductor layer 1011t is formed as a printed pattern to remain only in the groove 1012a. Note that, after the top surface conductor layer 1011t is printed on the second insulating layer 1012, the top surface conductor layer 1011t may remain only in the groove 1012a by the photolithography process.

As shown in FIG. 5D, a third insulating layer 1013 is printed on the second insulating layer 1012. The third insulating layer 1013 has a first groove 1013a and a second groove 1013b. The first groove 1013a and the second groove 1013b are formed in the same method as described in FIG. 5B.

As shown in FIG. 5E, a first penetration conductor layer 1131 as a first layer is printed in the first groove 1013a, and a second penetration conductor layer 1141 as the other first layer is printed in the second groove 1013b. The first penetration conductor layer 1131 as the first layer and the second penetration conductor layer 1141 as the other first layer are formed by the same method described in FIG. 5C.

By repeating the above-described processes, as shown in FIG. 5F, a fourth insulating layer 1014 is provided on the third insulating layer 1013, and a first penetration conductor layer 1132 as a second layer and a second penetration conductor layer 1142 as the other second layer are provided in two respective grooves provided in the fourth insulating layer 1014. Further, a fifth insulating layer 1015 is provided on the fourth insulating layer 1014, and a first penetration conductor layer 1133 as a third layer and a second penetration conductor layer 1143 as the other third layer are provided in two respective grooves provided in the fifth insulating layer 1015.

As shown in FIG. 5G, a sixth insulating layer 1016 is provided on the fifth insulating layer 1015, and a bottom surface conductor layer 1011b is provided in a groove provided in the sixth insulating layer 1016. A material of the bottom surface conductor layer 1011b is the same as the material of the top surface conductor layer 1011t. FIG. 5H shows the same step as that in FIG. 5G. As shown in FIG. 5H, a groove 1016a is provided in the sixth insulating layer 1016, and the bottom surface conductor layer 1011b is provided in the groove 1016a. The groove 1016a is a part of the recess C.

As shown in FIG. 5I, a seventh insulating layer 1017 is provided on the sixth insulating layer 1016. Subsequently, a groove is provided in the seventh insulating layer 1017 so that at least a part of the bottom surface conductor layer 1011b connected to the first and second external electrodes is exposed. FIG. 5J shows the same step as that in FIG. 5I. As shown in FIG. 5J, a groove 1017a is provided in the seventh insulating layer 1017. The groove 1017a is a part of the recess C. In this embodiment, a size of an opening of the groove 1017a is larger than a size of an opening of the groove 1016a. Consequently, it is possible to form the side surface of the recess C into the stepped shape.

As shown in FIG. 5K, an entire layered body is sintered in a furnace at a high temperature (for example, 500° C. or higher). The first to seventh insulating layers 1011 to 1017 are sintered to form the element body 10, the top surface conductor layer 1011t is sintered to form the top surface wiring 11t, the bottom surface conductor layer 1011b is sintered to form the bottom surface wiring 11b, the first penetration conductor layers 1131 to 1133 as the first to third layers are sintered to form the first penetration wiring 13, the second penetration conductor layers 1141 to 1143 as the first to third other layers are sintered to form the second penetration wiring 14. Hence, it is possible to improve the strength by sintering the insulating layers, and a resin component which does not need to be contained in the conductor layers can be volatilized by sintering the conductor layers, and a conductor material contained in the conductor layers can be fused to realize high conductivity. The base substrate 1000 may be peeled off by decomposing a surface during sintering, may be mechanically removed by performing grinding or the like before and after the sintering, or may be chemically removed by performing etching or the like before and after the sintering. FIG. 5L shows the same step as that in FIG. 5K. As shown in FIG. 5L, the element body 10 in which the recess C is provided in the bottom surface 100b is formed by the sintering.

As shown in FIG. 5M, for example, a conductive material such as Cu, Ni, Ti, or a combination thereof is deposited by a sputtering method, and etched into a predetermined shape by a photolithography method, and the base layer 121e1 is formed. The predetermined shape is a shape to allow the base layer 121e1 to cover at least an inner surface of the recess C. Subsequently, the plating layer 121e2 is formed by electroless plating to cover the base layer 121e1. The plating layer 121e2 is, for example, Ni/Au. In this manner, the external electrodes 121 and 122 are formed. FIG. 5N shows the same step as that in FIG. 5M. As shown in FIG. 5N, the first external electrode 121 is in contact with the exposed part of the endmost coil wiring 11e from the element body 10, and the protrusion P is formed on the first external electrode 121. Although not shown, the second external electrode 122 is in contact with the exposed part of the endmost coil wiring 11e from the element body 10, and the protrusion P is formed on the second external electrode 122.

As shown in FIG. 5O, division into individual components is performed along a cutting line D. Consequently, as shown in FIG. 3, the inductor component 1 is manufactured.

### 3. Modification Examples

### First Modification Example

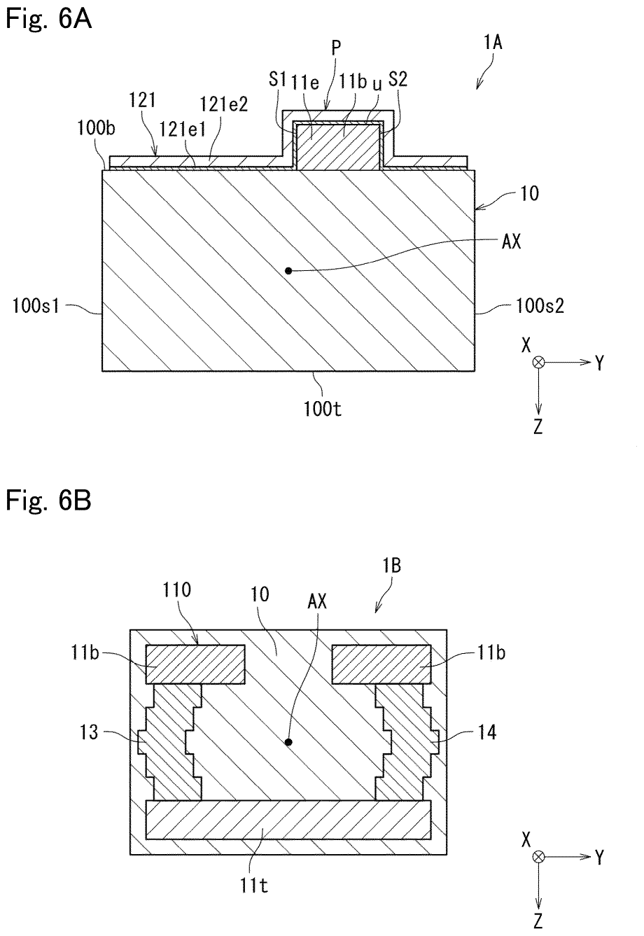

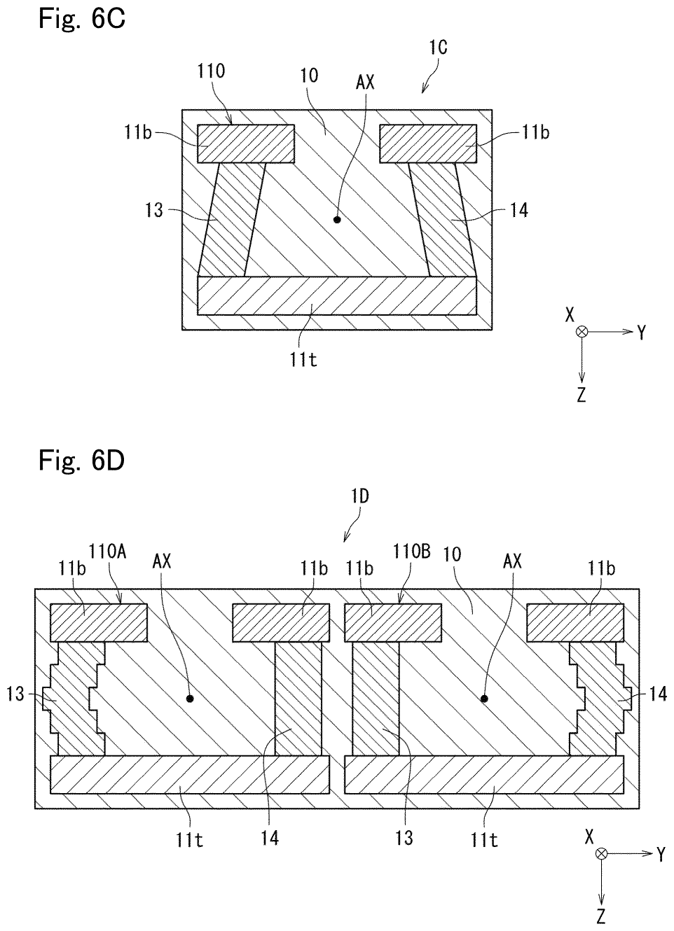

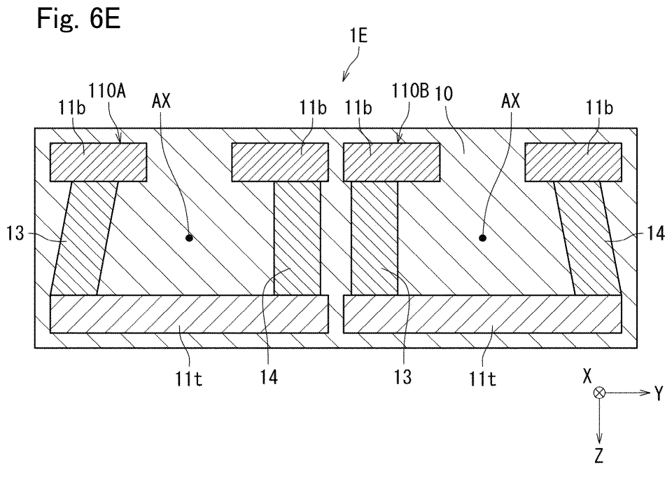

FIG. 6A is a view showing a first modification example of the inductor component, and the view corresponds to the cross section taken along line III-III in FIG. 1. As shown in FIG. 6A, in an inductor component 1A of the first modification example, the element body 10 is not provided in a region on a side in the forward Y direction and a region on a side in the reverse Y direction with respect to the part of the endmost coil wiring 11e exposed from the element body 10. This enables the first external electrode 121 to be easily brought in contact with the bottom surface 100b of the element body 10.

### Second Modification Example

FIG. 6B is a view showing a second modification example of the inductor component, and the view corresponds to the cross section taken along line II-II in FIG. 1. As shown in FIG. 6B, in an inductor component 1B of the second modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction. In addition, each of the first penetration wiring 13 and the second penetration wiring 14 has a stepped shape in the Z direction. According to the configuration described above, in a case where the first penetration wiring 13 and the second penetration wiring 14 are each formed by layering a plurality of conductor layers, the first penetration wiring 13 and the second penetration wiring 14 can be easily formed in the stepped shape by shifting and layering each conductor layer.

### Third Modification Example

FIG. 6C is a view showing a third modification example of the inductor component, and the view corresponds to the cross section taken along line II-II in FIG. 1. As shown in FIG. 6C, in an inductor component 1C of the third modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wirings 13 and the second penetration wirings 14 are inclined such that a space therebetween is widened toward the top surface wiring 11t side in the Z direction. That is, each of the first penetration wirings 13 and the second penetration wirings 14 has a shape expanding outward in the radial direction of the coil 110 toward the top surface wiring 11t in the Z direction. As described above, the coil 110 has a trapezoidal shape when viewed from the axis AX direction. According to the configuration described above, the first penetration wirings 13 and the second penetration wirings 14 can be linearly formed and shortened, and the DC resistance of the first penetration wirings 13 and the second penetration wirings 14 can be reduced.

### Fourth Modification Example

FIG. 6D is a view showing a fourth modification example of the inductor component, and the view corresponds to the cross section taken along line II-II in FIG. 1. As shown in FIG. 6D, an inductor component 1D of the fourth modification example includes a first coil 110A and a second coil 110B as compared with the inductor component 1B of the second modification example shown in FIG. 6B.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1B of the second modification example. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has a stepped shape in the Z direction. According to the configuration described above, in a case where the first penetration wiring 13 is formed by layering a plurality of conductor layers, the first penetration wiring 13 can be easily formed in the stepped shape by shifting and layering each conductor layer.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1B of the second modification example. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has a stepped shape in the Z direction. According to the configuration described above, in a case where the second penetration wiring 14 is formed by layering a plurality of conductor layers, the second penetration wiring 14 can be easily formed in the stepped shape by shifting and layering each conductor layer.

### Fifth Modification Example

FIG. 6E is a view showing a fifth modification example of the inductor component, and the view corresponds to the cross section taken along line II-II in FIG. 1. As shown in FIG. 6E, an inductor component 1E of the fifth modification example includes a first coil 110A and a second coil 110B as compared with the inductor component 1C of the third modification example shown in FIG. 6C.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1C of the third modification example. Meanwhile, the second penetration wiring 14 has a linear shape parallel to the Z direction. That is, the first penetration wiring 13 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed and shortened, and the DC resistance of the first penetration wirings 13 and the second penetration wirings 14 can be reduced.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1C of the third modification example. Meanwhile, the first penetration wiring 13 has a linear shape parallel to the Z direction. That is, the second penetration wiring 14 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed, and the electrical resistance of the first penetration wirings 13 and the second penetration wirings 14 can be reduced.

### Second Embodiment

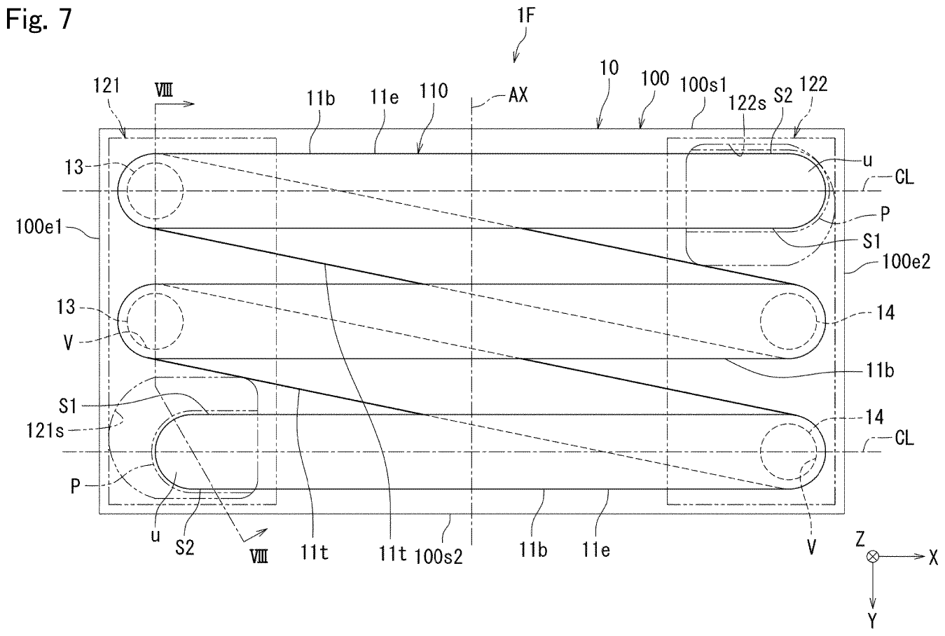

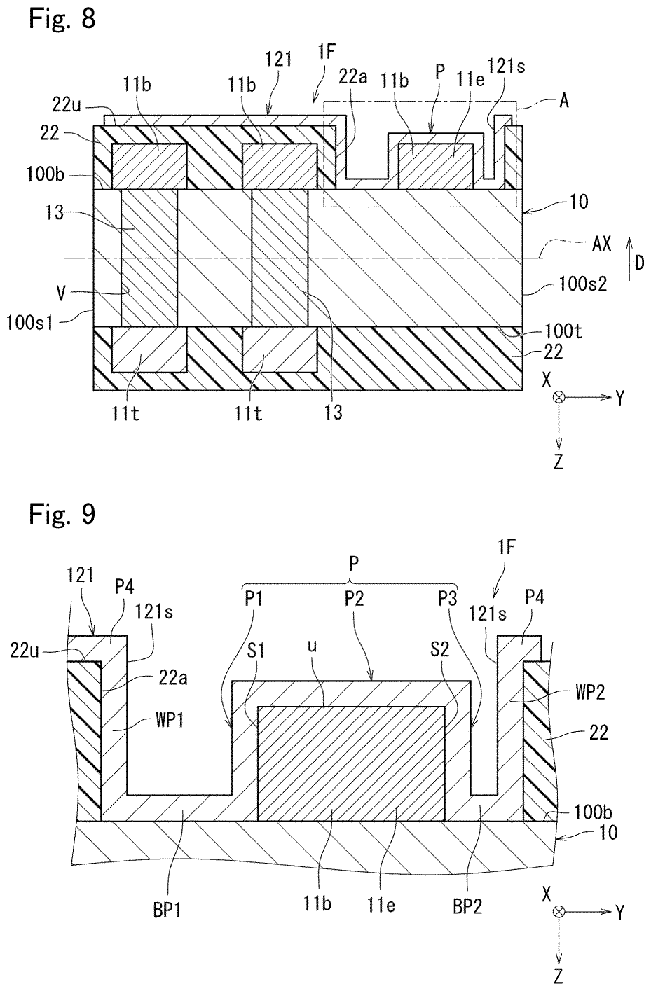

FIG. 7 is a schematic bottom view of a second embodiment of the inductor component from the bottom surface side. FIG. 8 is a cross-sectional view taken along line VIII-VIII in FIG. 7. FIG. 9 is an enlarged view of portion A of FIG. 8. In FIG. 7, for convenience, an insulating layer is omitted, and the external electrodes are drawn by two-dot chain lines. In addition, in FIG. 7, the element body 10 is drawn transparently so that a structure thereof can be easily understood. The second embodiment differs from the first embodiment mainly in the position of the axis of the coil, the orientation of the penetration wiring, the material of the element body, providing of an insulating body, and a configuration of the external electrode, and these different configurations will be described below. The other configurations are the same as those of the first embodiment, and the description thereof will be omitted.

### 1. Configurations of Respective Units

### (Inductor Component 1F)

As shown in FIG. 7, in an inductor component 1F, an axis AX of a coil 110 is perpendicular to the X direction. To be more specific, the axis AX is parallel to the Y direction and passes a center of the element body 10 in the X direction. This enables interference in magnetic flux of the coil 110 by the first external electrode 121 and the second external electrode 122 to be reduced, and it is possible to improve the efficiency of acquisition of inductance.

A length of the coil 110 in the axis AX direction is shorter than an inner diameter of the coil 110. This enables the Q value to be improved since the coil length is short and the coil inner diameter is large. The inner diameter of the coil indicates an equivalent circle diameter based on a minimum area of a region surrounded by the coil 110 when viewed therethrough in the axis AX direction.

### (Element Body 10)

The element body 10 is an inorganic insulating body. The material of the element body 10 is preferably glass, and this enables an eddy current to be reduced and enables the Q value to be increased since the glass has high insulation properties. The element body 10 preferably contains an Si element, and this enables the thermal stability of the element body 10 to be increased, thus, enabling variations in dimension or the like of the element body 10 due to heat to be reduced and enabling variations in electrical characteristics to be decreased.

The element body 10 is preferably a single-layer glass plate. This enables the strength of the element body 10 to be ensured. In addition, in the case of the single-layer glass plate, since dielectric loss is small, the Q value at a high frequency can be increased. In addition, since no sintering process for such a sintered body is performed, deformation of the element body 10 during sintering can be reduced. Hence, it is possible to reduce pattern misalignment and provide an inductor component with a small inductance tolerance.

As a material of the single-layer glass plate, a glass plate having photosensitivity represented by Foturan II (Schott AG's registered trademark) is preferable from the viewpoint of a manufacturing method. In particular, the single-layer glass plate preferably contains cerium oxide (ceria: CeO₂), and in this case, cerium oxide serves as a sensitizer, and processing by photolithography becomes easier.

However, since the single-layer glass plate can be processed by machining such as drilling or sandblasting, dry/wet etching using a photoresist/metal mask, laser processing, or the like, the single-layer glass plate may be a non-photosensitive glass plate. In addition, the single-layer glass plate may be obtained by sintering a glass paste, or may be formed by a known method such as a float process.

### (Coil 110)

As shown in FIG. 7, the bottom surface wiring 11b extends only in one direction. To be more specific, the bottom surface wirings 11b have a shape extending in the X direction. The plurality of bottom surface wirings 11b are arranged parallel to each other in the Y direction. The plurality of bottom surface wirings 11b include an endmost coil wiring 11e positioned on one side in the axis AX direction (Y direction). In this embodiment, of the plurality of bottom surface wirings 11b, both the two bottom surface wirings 11b positioned at both ends in the axis AX direction are the endmost coil wirings 11e. The top surface wirings 11t extend only in one direction. To be more specific, the top surface wirings 11t slightly tilt in the Y direction and extend in the X direction. The plurality of top surface wirings 11t are arranged parallel to each other in the Y direction.

The first penetration wirings 13 are disposed in the through-holes V of the element body 10 on the first end surface 100e1 side with respect to the axis AX, and the second penetration wirings 14 are disposed in the other through-holes V of the element body 10 on the second end surface 100e2 side with respect to the axis AX. Each of the first penetration wirings 13 and the second penetration wirings 14 extends in a direction orthogonal to the bottom surface 100b and the top surface 100t. The plurality of first penetration wirings 13 and the plurality of second penetration wirings 14 are all arranged parallel to each other in the Y direction.

### (Insulating Body 22)

As shown in FIG. 8, the inductor component 1F includes an insulating body 22. The insulating body 22 covers both the bottom surface 100b and the top surface 100t of the element body 10. Note that the insulating body 22 may be provided only on the bottom surface 100b of the bottom and top surfaces 100b and 1100t.

The insulating body 22 is a member that protects the wirings from an external force by covering the wirings (the bottom surface wirings 11b and the top surface wirings 11t), and has a role of preventing the wirings from being damaged and a role of improving insulation properties of the wirings. The insulating body 22 is preferably an organic insulating body. For example, the insulating body 22 may be a film made of a resin such as epoxy or polyimide which is easily formed. In particular, the insulating body 22 is preferably made of a material having a low dielectric constant. Consequently, in a case where the insulating body 22 is present between the coil 110 and the external electrode 121 or 122, it is possible to decrease the stray capacitance formed between the coil 110 and the external electrode 121 or 122. The insulating body 22 can be formed, for example, by laminating a resin film such as ABF GX-92 (manufactured by Ajinomoto Fine-Techno Co., Inc.), applying and thermal-curing a paste-like resin, or the like. Note that the insulating body 22 may be, for example, an inorganic film made of an oxide such as silicon or hafnium, a nitride, an oxynitride, or the like, which is excellent in insulating properties and thinning.

The insulating body 22 covering the bottom surface 100b has an opening 22a so that the connection part of the endmost coil wiring 11e which is connected to the external electrode 121 or 122 is exposed. The opening 22a is a through-hole penetrating the insulating body 22 in a thickness direction (Z direction) thereof. A shape of the opening 22a when viewed in the Z direction is not particularly limited as long as the connection part of the bottom surface wiring 11b is exposed. In this embodiment, as shown in FIG. 7, the shape of the opening 22a is sufficiently larger than a shape of the connection part of the bottom surface wiring 11b when viewed in the Z direction, and is similar to the shape of the connection part.

To be more specific, when viewed in the Z direction, in the endmost coil wiring 11e positioned on the second side surface 100s2 side with respect to the center of the element body 10, the shape of the connection part (in other words, the part of the endmost coil wiring 11e which is exposed from the insulating body 22) connected to the first external electrode 121 is a cannonball shape with a tip portion having a width in the Y direction, and the width becomes narrower toward the side in the reverse X direction. When viewed in the Z direction, the shape of the opening 22a provided on the first external electrode 121 side is sufficiently larger than the shape of the connection part, and is formed into a cannonball shape with a tip portion having a width in the Y direction, and the width becomes narrower toward the side in the reverse X direction so that the shape of the opening becomes similar to the shape of the connection part.

Similarly, when viewed in the Z direction, in the endmost coil wiring 11e positioned on the first side surface 100s1 side with respect to the center of the element body 10, the shape of the connection part (in other words, the part of the endmost coil wiring 11e which is exposed from the insulating body 22) connected to the second external electrode 122 is a cannonball shape with a tip portion having a width in the Y direction, and the width becomes narrower toward the side in the forward X direction. When viewed in the Z direction, the shape of the opening 22a provided on the second external electrode 122 side is sufficiently larger than the shape of the connection part, and is formed into a cannonball shape with a tip portion having a width in the Y direction, and the width becomes narrower toward the side in the forward X direction so that the shape of the opening becomes similar to the shape of the connection part. The shape of the opening 22a is sufficiently larger than the shape of the connection part, thereby enabling the connection part to be more reliably exposed from the insulating body 22, and the shape of the opening 22a is similar to the shape of the connection part, thereby enabling an etching amount of the insulating body 22 to be minimized so that insulation properties of the wiring can be ensured.

### (External Electrodes 121 and 122)

As shown in FIGS. 7, 8, and 9, the first external electrode 121 is provided to cover the entire opening 22a positioned on the first end surface 100e1 side when viewed in the Z direction. Consequently, the first external electrode 121 has a first part P1 in contact with at least a part of the first side surface S1 of the endmost coil wiring 11e, a second part P2 in contact with at least a part of the upper surface u of the endmost coil wiring 11e, and a third part P3 in contact with at least a part of the second side surface S2 of the endmost coil wiring 11e, and the first part P1, the second part P2, and the third part P3 are continuous in this order and form the protrusion P protruding toward the side in the first direction D1. To be more specific, the first external electrode 121 is in contact with an entire surface as a part of the first side surface S1 of the endmost coil wiring 11e which is exposed from the insulating body 22, is in contact with an entire surface as a part of the upper surface u of the endmost coil wiring 11e which is exposed from the element body 10, and is in contact with an entire surface as a part of the second side surface S2 of the endmost coil wiring 11e which is exposed from the element body 10. As a result, the first external electrode 121 has the protrusion P at a position corresponding to the part of the endmost coil wiring 11e which is exposed from the element body 10.

Similarly, the second external electrode 122 is provided to cover the entire opening 22a positioned on the second end surface 100e2 side when viewed in the Z direction. Consequently, the second external electrode 122 has a first part in contact with at least a part of the first side surface S1 of the endmost coil wiring 11e, a second part in contact with at least a part of the upper surface u of the endmost coil wiring 11e, and a third part in contact with at least a part of the second side surface S2 of the endmost coil wiring 11e, and the first part, the second part, and the third part are continuous in this order and form the protrusion P protruding toward the side in the first direction D1. To be more specific, the second external electrode 122 is in contact with an entire surface as a part of the first side surface S1 of the endmost coil wiring 11e which is exposed from the insulating body 22, is in contact with an entire surface as a part of the upper surface u of the endmost coil wiring 11e which is exposed from the element body 10, and is in contact with an entire surface as a part of the second side surface S2 of the endmost coil wiring 11e which is exposed from the element body 10. As a result, the second external electrode 122 has the protrusion P at a position corresponding to the part of the endmost coil wiring 11e which is exposed from the element body 10.

Preferably, when viewed in the direction (Z direction) orthogonal to the bottom surface 100b, the first external electrode 121 and the second external electrode 122 are positioned on an inner side with respect to the outer surface 100 of the element body 10. According to this configuration, since the first external electrode 121 and the second external electrode 122 are not in contact with the outer surfaces 100 of the element body 10, loads applied to the first external electrode 121 and the second external electrode 122 can be decreased, and deformation and peeling of the first external electrode 121 and the second external electrode 122 can be reduced, when division into individual inductor components 1F is performed. Therefore, even if the inductor component 1F has a small size, it is possible to prevent the first external electrode 121 and the second external electrode 122 from being deformed or peeled off.

According to the inductor component 1F, since the first external electrode 121 and the second external electrode 122 have the respective protrusions P protruding toward the side in the first direction D1, a surface area is increased as compared with the case of a flat surface without the protrusion P, and it is possible to improve the fixing strength with a connection member such as solder. In addition, since the protrusions P of the first external electrode 121 and the second external electrode 122 are in contact with the respective endmost coil wirings 11e, it is possible to directly connect both the first external electrode 121 and the second external electrode 122 and the respective endmost coil wirings 11e are directly to each other. Consequently, it is possible to decrease the direct current resistance (Rdc) as compared with a case where both the first external electrode 121 and the second external electrode 122 and the endmost coil wirings 11e are connected by, for example, via wirings or the like, respectively.

Preferably, as shown in FIG. 9, the insulating body 22 is further provided on a part of the bottom surface 100b, and at least a part of the first external electrode 121 is continuously provided in contact with the insulating body 22, the bottom surface 100b, and the first side surface S1 of the protrusion P. To be more specific, the first external electrode 121 includes a bottom portion BP1 which is provided continuously from the first part P1 of the protrusion P to the side opposite to the second part P2 and extends in the direction parallel to the bottom surface 100b, and a wall portion WP1 which is provided continuously from the bottom portion BP1 and extends in the first direction D1. The wall portion WP1, the bottom portion BP1, and the first part P1 are continuously provided in contact with the insulating body 22, the bottom surface 100b, and the first side surface S1 of the protrusion P.

In addition, in this embodiment, at least a part of the first external electrode 121 is continuously provided in contact with the insulating body 22, the bottom surface 100b, and the second side surface S2 of the protrusion P. To be more specific, the first external electrode 121 includes a bottom portion BP2 which is provided continuously from the third part P3 of the protrusion P to the side opposite to the second part P2 and extends in the direction parallel to the bottom surface 100b, and a wall portion WP2 which is provided continuously from the bottom portion BP2 and extends in the first direction D1. The wall portion WP2, the bottom portion BP2, and the third part P3 are provided continuously in contact with the insulating body 22, the bottom surface 100b, and the second side surface S2 of the protrusion P.

According to the configuration described above, since at least a part of the first external electrode 121 is continuously provided in contact with the insulating body 22, the bottom surface 100b, and the first side surface S1 of the protrusion P, the first external electrode 121 is formed into an uneven shape. Therefore, it is possible to further improve the fixing strength with the connection member such as solder. In addition, since at least a part of the first external electrode 121 is continuously provided in contact with the insulating body 22, the bottom surface 100b, and the second side surface S2 of the protrusion P, the first external electrode 121 is formed into an uneven shape. Therefore, it is possible to further improve the fixing strength with the connection member such as solder.

Similarly, at least a part of the second external electrode 122 may be continuously provided in contact with the insulating body 22, the bottom surface 100b, and the first side surface S1 of the protrusion P.

Preferably, the first external electrode 121 further includes a fourth part P4 which is separated from the second part P2 and is positioned on a side in the first direction D1 from the second part P2. To be more specific, the fourth part P4 is a part of the first external electrode 121 provided on the upper surface 22u of the insulating body 22. According to this configuration, since the first external electrode 121 further includes the fourth part P4, it is possible to further increase the surface area of the first external electrode 121. Similarly, the second external electrode 122 may further include a fourth part which is separated from the second part and is positioned on a side in the first direction D1 from the second portion.

### (Method for Manufacturing Inductor Component 1F)

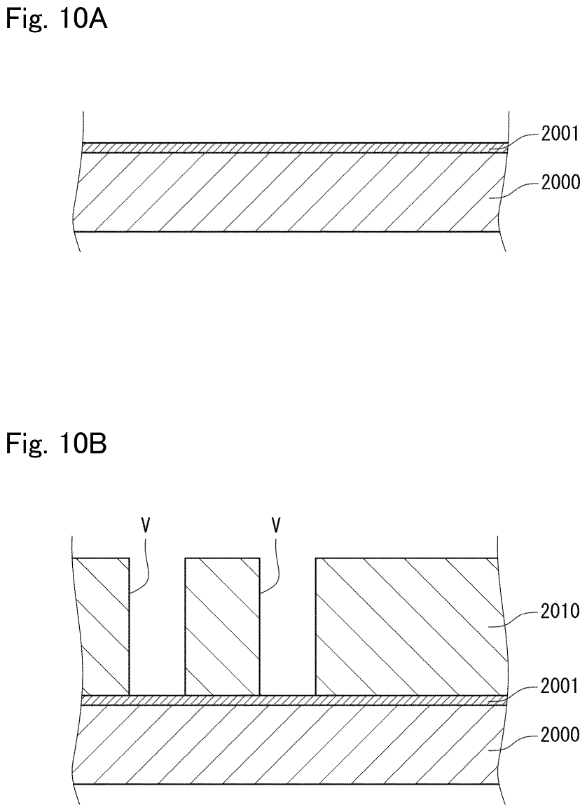

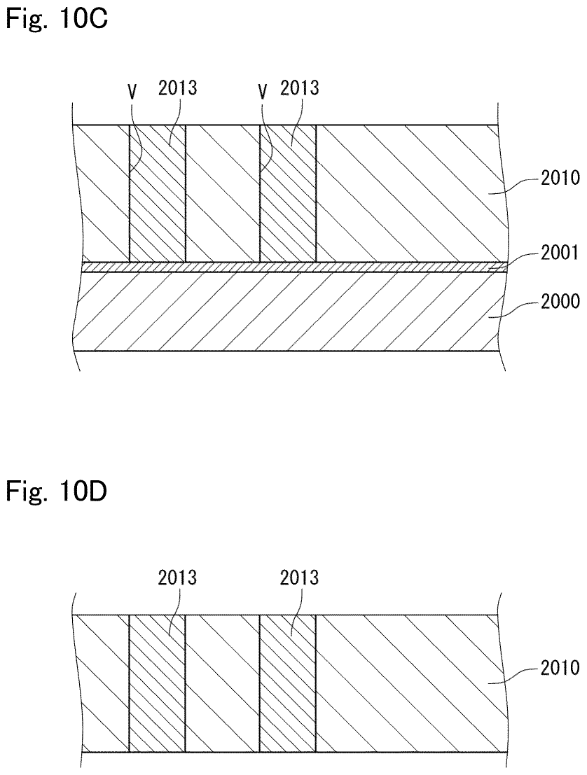

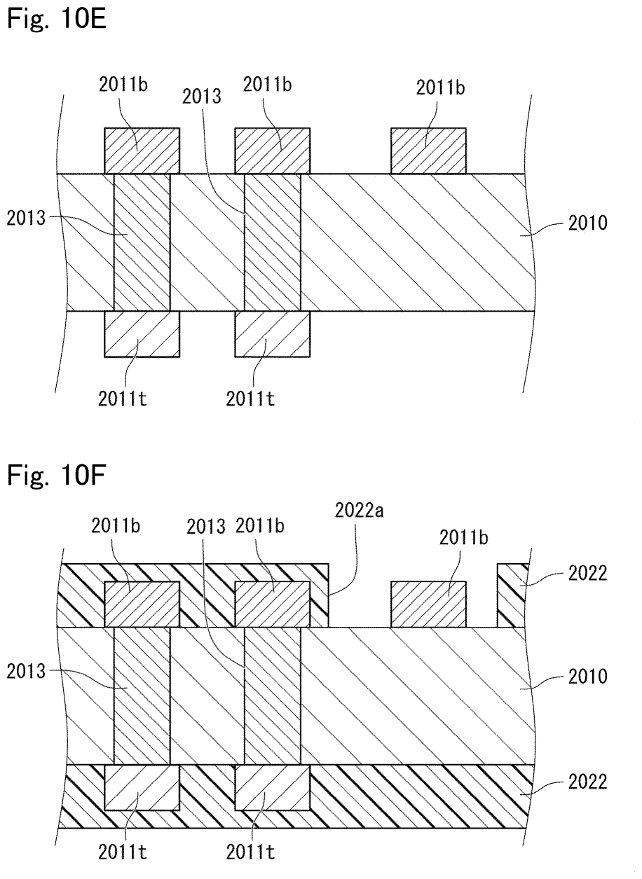

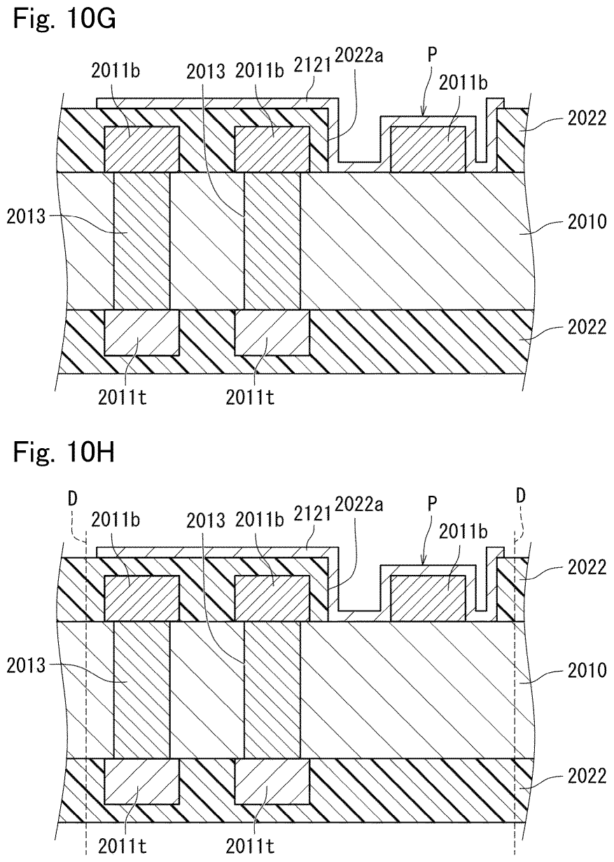

Next, a method for manufacturing the inductor component 1F will be described with reference to FIGS. 10A to 10H. FIGS. 10A to 10H are views corresponding to a cross section taken along line VIII-VIII in FIG. 7.

As shown in FIG. 10A, copper foil 2001 is printed on a base substrate 2000. A material of the base substrate 2000 is the same as that of the base substrate 1000 of the first embodiment.

As shown in FIG. 10B, a glass substrate 2010 which becomes the element body 10 is provided on the base substrate 2000. For example, the base substrate 2000 and the glass substrate 2010 are brought into close contact with each other using a jig such as a conductive tape, a pin, or a frame. The glass substrate 2010 has a through-hole V. The glass substrate 2010 is, for example, a through glass via (TGV) substrate. The TGV substrate is a substrate in which a through-hole is formed in advance by a laser, photolithography, or the like. The glass substrate 2010 may be, for example, a through silicon via (TSV) substrate, or may be another substrate. In addition, Ti/Cu or other necessary conductive materials may be deposited on a surface of the glass substrate 2010 in advance as seeds by sputtering or the like.

As shown in FIG. 10C, a first penetration conductor layer 2013 which becomes the first penetration wiring 13 is formed in the through-hole V of the glass substrate 2010. Although not shown, similarly, a second penetration conductor layer which becomes the second penetration wiring 14 is formed in the through-hole V. To be more specific, by supplying electric power from the copper foil 2001 on the base substrate 2000, electrolytic plating is performed on the through-hole V of the glass substrate 2010 to form the first penetration conductor layer 2013. Otherwise, a seed layer may be formed on the surface of the glass substrate 2010 or an inner surface of the through-hole V by sputtering or the like, and the penetration conductor layer may be formed by using a known method such as fill plating, conformal plating, or a printing filling method of a conductive paste. In a case where there is unnecessary plating growth on the surface of the glass substrate 2010, an unnecessary part is removed by polishing, CMP, wet etching (etchback), or dry etching.

As shown in FIG. 10D, the base substrate 2000 is peeled off from the glass substrate 2010. In this case, the base substrate 2000 may be mechanically removed by grinding or the like, or may be chemically removed by etching or the like.

As shown in FIG. 10E, a bottom surface conductor layer 2011b which becomes the bottom surface wiring 11b and a top surface conductor layer 2011t which becomes the top surface wiring 11t are formed on the glass substrate 2010. To be more specific, a seed layer (not shown) is provided on the entire surface of the glass substrate 2010, and patterned photoresist is formed on the seed layer. A copper layer is formed on the seed layer in an opening portion of the photoresist by electrolytic plating. The photoresist and the seed layer are removed by wet etching or dry etching. Consequently, the bottom surface conductor layer 2011b and the top surface conductor layer 2011t patterned in an arbitrary shape are formed. In this case, the bottom surface conductor layer 2011b and the top surface conductor layer 2011t may be formed one by one, or may be formed simultaneously.

As shown in FIG. 10F, an insulating layer 2022 serving as the insulating body 22 is provided on a top surface and a bottom surface of the glass substrate 2010 to cover the conductor layer. In this case, the insulating layer 2022 on the bottom surface side and the insulating layer 2022 on the top surface side may be formed one by one, or may be formed simultaneously. Thereafter, a hole 2022a is formed in the bottom surface conductor layer 2011b of the insulating layer 2022 on the bottom surface side by photolithography or laser processing. At this time, a part of the bottom surface conductor layer 2011b which is the connection part connected to the first or second external electrode is exposed from the insulating layer 2022. The hole 2022a becomes the opening 22a.

As shown in FIG. 10G, a first external electrode conductor layer 2121 which becomes the first external electrode 121 is provided on the insulating layer 2022 on the bottom surface side. In this case, the first external electrode conductor layer 2121 is connected to the bottom surface conductor layer 2011b via the hole 2022a. In addition, the first external electrode conductor layer 2121 is in contact with the bottom surface conductor layer 2011b via the hole 2022a and forms the protrusion P. To be more specific, a Pd catalyst (not shown) is provided on the insulating layer 2022 on the bottom surface side, and an Ni/Au plated layer is formed by electroless plating. Patterned photoresist is formed on the plating layer. A plating layer in an opening portion of the photoresist is removed by wet etching or dry etching. Consequently, the first external electrode conductor layer 2121 patterned in an arbitrary shape is formed. Alternatively, a seed layer (not shown) is provided on the insulating layer 2022 on the bottom surface side, and the patterned photoresist is formed on the seed layer. Next, the seed layer in the opening portion of the photoresist is removed by wet etching or dry etching. An Ni/Au plating layer may be formed on the remaining seed layer by electroless plating. Although not shown, a second external electrode conductor layer which becomes the second external electrode 122 is provided on the insulating layer 2022 on the bottom surface side.

As shown in FIG. 10H, division into individual components is performed along a cutting line D. Consequently, as shown in FIG. 8, the inductor component 1F is manufactured.

### 2. Modification Examples

### First Modification Example

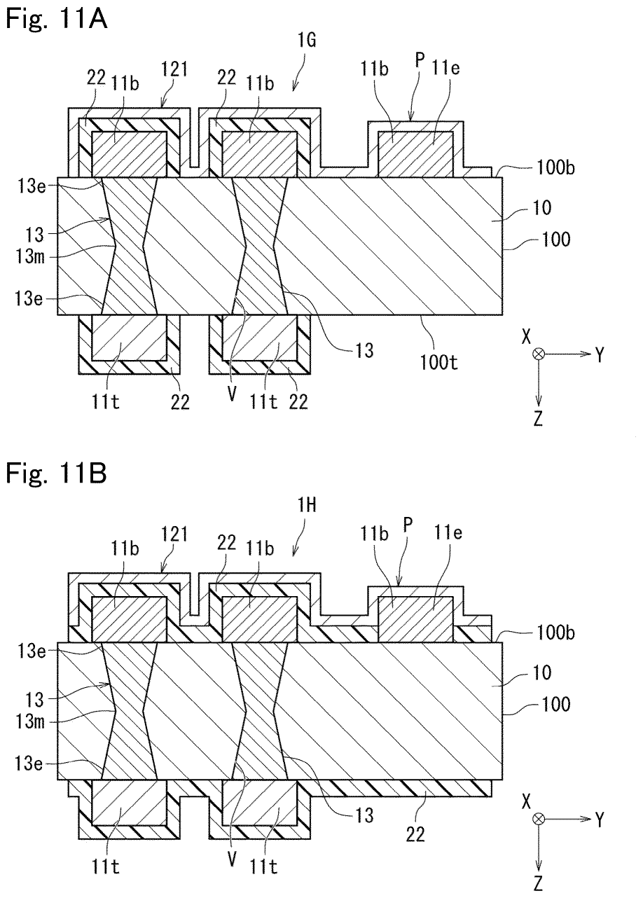

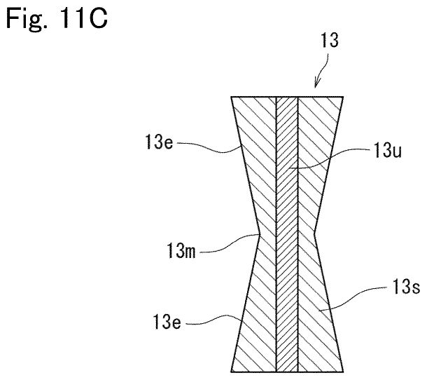

FIG. 11A is a view showing a first modification example of the inductor component, and the view corresponds to a cross section taken along line VIII-VIII in FIG. 7. As shown in FIG. 11A, in an inductor component 1G of the first modification example, the first penetration wiring 13 extends in a direction orthogonal to the bottom surface wiring 11b, and a cross-sectional area of each of both end portions 13e of the first penetration wiring 13 in an extending direction thereof is larger than a cross-sectional area of a central portion 13m of the first penetration wiring 13 in the extending direction. That is, in a cross section of the first penetration wiring 13 in the extending direction, a width of the first penetration wiring 13 in a direction orthogonal to the extending direction continuously increases from the central portion 13m toward both the end portions 13e.

This enables the cross-sectional area of the end portion 13e of the first penetration wiring 13 to be increased, so that the connectivity between the first penetration wiring 13 and at least one of the bottom surface wiring 11b and the top surface wiring 11t can be improved. In addition, when the through-hole V is formed as a hole portion in the element body 10, the through-hole V is filled with a conductive material by fill plating or the like, and the first penetration wiring 13 is formed in the through-hole V, it is easy to fill the through-hole V on an opening side with the conductive material. Since the cross-sectional area of the end portion 13e of the first penetration wiring 13 is large, and the cross-sectional area of the central portion 13m of the first penetration wiring 13 is small, the first penetration wiring 13 is easily formed.

Note that the cross-sectional area of one end portion 13e of the first penetration wiring 13 may be larger than the cross-sectional area of the central portion 13m of the first penetration wiring 13. Similarly, the cross-sectional area of at least one end portion of the second penetration wiring 14 may be larger than the cross-sectional area of the central portion 13m of the first penetration wiring 13.

In addition, in the inductor component 1G of the first modification example, the bottom surface wiring 11b further includes the insulating body 22 that is provided on the bottom surface 100b, covers the bottom surface wiring 11b, and has a shape conforming to the shape of the bottom surface wiring 11b, and at least a part of the first external electrode 121 is in contact with the insulating body 22 and has a shape conforming to the shape of the bottom surface wiring 11b. To be more specific, the insulating body 22 covers the bottom surface wiring 11b, has a shape extending in the X direction when viewed in the Z direction, and has a shape conforming to the shape of the bottom surface wiring 11b. In short, the insulating body 22 is provided to separately cover the individual bottom surface wirings 11b. In a region between the adjacent bottom surface wirings 11b, the bottom surface 100b is exposed from the insulating body 22. A part of the first external electrode 121 excluding the protrusion P and the part thereof in contact with the bottom surface 100b is in contact with the insulating body 22, has a shape extending in the X direction when viewed in the Z direction, and has a shape conforming to the shape of the bottom surface wiring 11b.

In addition, the insulating body 22 covers the top surface wiring 11t, has a shape slightly inclined in the Y direction and extending in the X direction when viewed in the Z direction, and has a shape conforming to the shape of the top surface wiring 11t. In short, the insulating body 22 is provided to separately cover the individual top surface wirings 11t. Consequently, it is possible to decrease material costs of the insulating body 22.

Examples of a method of forming the insulating body 22 having a shape conforming to the shape of the bottom surface wiring 11b or the top surface wiring 11t include a method of forming an organic resin or inorganic insulating body on the surface of the bottom surface wiring 11b or the top surface wiring 11t by using a method such as chemical vapor deposition (CVD), sputtering, or coating.

According to the configuration described above, since at least a part of the first external electrode 121 has a shape conforming to the shape of the bottom surface wiring 11b, it is possible to further increase the surface area of the first external electrode 121 such that it is possible to further improve the fixing strength with the connection member such as solder.

Similarly, at least a part of the second external electrode 122 may be in contact with the insulating body 22 and have a shape conforming to the shape of the bottom surface wiring 11b.

### Second Modification Example

FIG. 11B is a view showing a second modification example of the inductor component, and the view corresponds to a cross section taken along line VIII-VIII in FIG. 7. As shown in FIG. 11B, in an inductor component 1H of the second modification example, as compared with the inductor component 1G of the first modification example, the insulating body 22 is further provided on the entire surface of a part of the bottom surface 100b excluding an outer circumferential part thereof and the part where the bottom surface wiring 11b is provided. A thickness of the insulating body 22 in the Z direction is smaller than a thickness of the bottom surface wiring 11b in the Z direction. According to this configuration, since an area of a part of the first external electrode 121 which is in opposite to the bottom surface wiring 11b is smaller than that in the first modification example, it is possible to decrease stray capacitance that can be generated between the first external electrode 121 and the bottom surface wiring 11b as compared with the first modification example. In addition, since the insulating body 22 fills a space between the adjacent bottom surface wirings 11b as compared with the first modification example, it is possible to ensure insulation properties between the adjacent bottom surface wirings 11b as compared with the first modification example.

In addition, in the inductor component 1H of the second modification example, when the element body 10 is the inorganic insulating body, and the insulating body 22 is an organic insulating body, the organic insulating body is positioned on an inner side with respect to the outer surfaces 100 of the inorganic insulating body when viewed in the direction orthogonal to the bottom surface 100b. According to this, since the organic insulating body is provided, the organic insulating body easily imparts flowability, the organic insulating body easily fills a space between wirings adjacent to each other and enables insulating properties to be improved, in a case where the wirings (the bottom surface wirings 11b and the top surface wirings 11t) are covered with the organic insulating body. In addition, since the organic insulating body is not in contact with the outer surface of the inorganic insulating body, it is possible to decrease a load applied to the organic insulating body and reduce deformation and peeling of the organic insulating body when division into the individual inductor components 1H is performed.

In addition, in the inductor component 1H of the second modification example, as compared with the inductor component 1G of the first modification example, the insulating body 22 is further provided on the entire surface of a region of the top surface 100t excluding an outer circumferential part thereof and the part where the top surface wiring 11t is provided. A thickness of the insulating body 22 in the Z direction is smaller than a thickness of the top surface wiring 11t in the Z direction. Consequently, it is possible to protect the element body 10 from an external environment.

### Third Modification Example

FIG. 11C is a schematic cross-sectional view of the first penetration wiring showing a third modification example of the inductor component. As shown in FIG. 11C, in the third modification example, the first penetration wiring 13 includes a conductive layer 13s positioned on an outer circumferential side thereof when viewed from an extending direction of the first penetration wiring 13, and a non-conductive layer 13u positioned inside the conductive layer 13s. This prevents the Q value from being reduced by providing the conductive layer 13s on the outer circumferential side since a current mainly flows in a surface of the first penetration wiring 13 due to a skin effect in the case of use in a high frequency band. In addition, by providing the non-conductive layer 13u inside, stress can be alleviated, and manufacturing costs can be reduced by using no conductor.

An example of a method of forming the conductive layer 13s and the non-conductive layer 13u will be described. A seed layer is provided on the inner surface of the through-hole V of the element body 10 by sputtering or electroless plating. A plating layer is formed on the seed layer by electrolytic plating. In this manner, for example, a plurality of conductive layers 13s of Ti/Cu/electrolytic Cu, Pd/electroless Cu/electrolytic Cu, or the like can be formed on the first penetration wiring 13 on the outer circumferential side thereof. Thereafter, the inside of the conductive layer 13s is sealed with a resin by printing, hot pressing, or the like to form the non-conductive layer 13u made of a resin. In this manner, stress can be alleviated by the non-conductive layer 13u inside the first penetration wiring 13 while a current flows in the surface (the conductive layer 13s) of the first penetration wiring 13.

Similarly, the second penetration wiring 14 may include a conductive layer positioned on an outer circumferential side thereof when viewed from an extending direction of the second penetration wiring 14, and a non-conductive layer positioned inside the conductive layer.

Note that the present disclosure is not limited to the embodiments described above, and can be modified in design without departing from the gist of the present disclosure. For example, the individual characteristic points of the first and second embodiments may be variously combined.

In the embodiments, both the first external electrode and the second external electrode have the protrusion, but only one of the first external electrode and the second external electrode may have the protrusion. In this case, the external electrode without having the protrusion may be connected to the bottom surface wiring via a via wiring or the like provided in the element body, for example.

The present disclosure includes the following aspects.

<1> An inductor component including an element body having a first principal surface and a second principal surface opposite to each other; a coil that has at least a part provided in the element body and is wound in a spiral shape along an axis; and a first external electrode and a second external electrode that are provided outside the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. The plurality of first coil wirings include an endmost coil wiring provided at an endmost position on one side in the axial direction. The endmost coil wiring has an upper surface positioned on a side in a first direction from the second principal surface side toward the first principal surface side, and a first side surface and a second side surface positioned on both sides sandwiching a center line of the endmost coil wiring in an extending direction thereof when viewed in a direction orthogonal to the first principal surface. Also, the first external electrode includes a first part in contact with at least a part of the first side surface, a second part in contact with at least a part of the upper surface, and a third part in contact with at least a part of the second side surface, and the first part, the second part, and the third part are continuous in this order and form a protrusion protruding toward one side in the first direction.

<2> The inductor component according to <1>, in which the first external electrode has a thickness smaller than a thickness of the first coil wirings.

<3> The inductor component according to <1> or <2>, in which the element body contains SiO₂.

<4> The inductor component according to any one of <1> to <3>, in which the first external electrode includes a plurality of conductive layers including a conductive layer made of a material different from a material of a conductive layer of the endmost coil wiring.

<5> The inductor component according to any one of <1> to <4>, in which the first external electrode further includes a bottom portion which is provided continuously from the first part of the protrusion to a side opposite to the second part and extends in a direction parallel to the first principal surface; and a wall portion which is provided continuously from the bottom portion and extends in the first direction.

<6> The inductor component according to any one of <1> to <5>, in which the first external electrode further includes a fourth part which is separated from the second part and is positioned closer to the side in the first direction than the second part is.

<7> The inductor component according to any one of <1> to <6>, in which the first principal surface has a recess, the recess has a side surface having a stepped shape, and at least a part of the first external electrode has a shape which is in contact with the side surface and conforms to the side surface.

<8> The inductor component according to any one of <1> to <7>, further including an insulating body provided on a part of the first principal surface, in which at least a part of the first external electrode is continuously in contact with the insulating body, the first principal surface, and the first side surface of the protrusion.

<9> The inductor component according to any one of <1> to <8>, in which the first coil wiring is provided in the first principal surface, the inductor component further includes an insulating body that covers the first coil wiring and has a shape conforming to a shape of the first coil wiring, and at least a part of the first external electrode is in contact with the insulating body and has a shape conforming to the shape of the first coil wiring.

<10> The inductor component according to any one of <1> to <9>, further including an organic insulating body provided on the first principal surface, in which the element body is an inorganic insulating body, and the organic insulating body is positioned on an inner side with respect to an outer surface of the inorganic insulating body when viewed in the direction orthogonal to the first principal surface.

<11> The inductor component according to any one of <1> to <10>, in which, when viewed in a direction parallel to the axis, the first penetration wirings and the second penetration wirings are not parallel to each other.

<12> The inductor component according to any one of <1> to <11>, in which the element body contains SiO₂, and the first penetration wirings contain SiO₂.

<13> The inductor component according to any one of <1> to <12>, in which each of the first penetration wirings has a void portion or a resin portion.

<14> The inductor component according to any one of <1> to <13>, in which each of the first penetration wirings includes a conductive layer positioned on an outer circumferential side when viewed in an extending direction of the first penetration wirings, and a non-conductive layer positioned inside the conductive layer.

<15> The inductor component according to any one of <1> to <14>, in which a length of the coil in an axial direction is shorter than an inner diameter of the coil.

<16> The inductor component according to any one of <1> to <15>, in which the first penetration wirings extend in the direction orthogonal to the first principal surface, and a cross-sectional area of at least one of both end portions of each of the first penetration wirings in the extending direction is larger than a cross-sectional area of a central portion of each of the first penetration wirings in the extending direction.

<17> The inductor component according to any one of <1> to <16>, in which the inductor component has a thickness of 200 μm or smaller.

<18> The inductor component according to any one of <1> to <17>, in which, when viewed in the direction orthogonal to the first principal surface, the first external electrode and the second external electrode are positioned on an inner side with respect to an outer surface of the element body.

What is claimed is:

1. An inductor component comprising:
an element body having a first principal surface and a second principal surface opposite to each other;
a coil that has at least a part in the element body and is wound in a spiral shape along an axis; and
a first external electrode and a second external electrode that are outside the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order,
the plurality of first coil wirings include an endmost coil wiring at an endmost position on one side in the axial direction,
the endmost coil wiring has an upper surface on a side in a first direction from the second principal surface side toward the first principal surface side, and a first side surface and a second side surface on both sides sandwiching a center line of the endmost coil wiring in an extending direction thereof when viewed in a direction orthogonal to the first principal surface, and
the first external electrode includes a first part in contact with at least a part of the first side surface, a second part in contact with at least a part of the upper surface, and a third part in contact with at least a part of the second side surface, and the first part, the second part, and the third part are continuous in this order and configure a protrusion protruding toward one side in the first direction.

2. The inductor component according to claim 1 wherein
the first external electrode has a thickness smaller than a thickness of the first coil wirings.

3. The inductor component according to claim 1, wherein
the element body includes SiO₂.

4. The inductor component according to claim 1, wherein
the first external electrode includes a plurality of conductive layers including a conductive layer made of a material different from a material of a conductive layer of the endmost coil wiring.

5. The inductor component according to claim 1, wherein
the first external electrode further includes a bottom portion which continuous from the first part of the protrusion to a side opposite to the second part and extends in a direction parallel to the first principal surface; and
a wall portion which is continuous from the bottom portion and extends in the first direction.

6. The inductor component according to claim 1, wherein
the first external electrode further includes a fourth part which is separated from the second part and is closer to the side in the first direction than the second part is.

7. The inductor component according to claim 1, wherein
the first principal surface has a recess,
the recess has a side surface having a stepped shape, and
at least a part of the first external electrode has a shape which is in contact with the side surface and conforms to the side surface.

8. The inductor component according to claim 1, further comprising:
an insulating body provided on a part of the first principal surface, wherein
at least a part of the first external electrode is continuously in contact with the insulating body, the first principal surface, and the first side surface of the protrusion.

9. The inductor component according to claim 1, wherein
the first coil wiring is in the first principal surface,
the inductor component further comprises an insulating body that covers the first coil wiring and has a shape conforming to a shape of the first coil wiring, and
at least a part of the first external electrode is in contact with the insulating body and has a shape conforming to the shape of the first coil wiring.

10. The inductor component according to claim 1, further comprising:
an organic insulating body on the first principal surface, wherein
the element body is an inorganic insulating body, and the organic insulating body is on an inner side with respect to an outer surface of the inorganic insulating body when viewed in the direction orthogonal to the first principal surface.

11. The inductor component according to claim 1, wherein
when viewed in a direction parallel to the axis, the first penetration wirings and the second penetration wirings are not parallel to each other.

12. The inductor component according to claim 1, wherein
the element body includes SiO₂, and
the first penetration wirings include SiO₂.

13. The inductor component according to claim 1, wherein
each of the first penetration wirings has a void portion or a resin portion.

14. The inductor component according to claim 1, wherein
each of the first penetration wirings includes a conductive layer on an outer circumferential side when viewed in an extending direction of the first penetration wirings, and a non-conductive layer inside the conductive layer.

15. The inductor component according to claim 1, wherein
the coil has a length in an axial direction thereof which is shorter than an inner diameter of the coil.

16. The inductor component according to claim 1, wherein
the first penetration wirings extend in the direction orthogonal to the first principal surface, and
a cross-sectional area of at least one of both end portions of each of the first penetration wirings in the extending direction is larger than a cross-sectional area of a central portion of each of the first penetration wirings in the extending direction.

17. The inductor component according to claim 1, wherein
the inductor component has a thickness of 200 μm or smaller.

18. The inductor component according to claim 1, wherein
when viewed in the direction orthogonal to the first principal surface, the first external electrode and the second external electrode are on an inner side with respect to an outer surface of the element body.

19. The inductor component according to claim 2, wherein
the element body includes SiO₂.

20. The inductor component according to claim 2, wherein
the first external electrode includes a plurality of conductive layers including a conductive layer made of a material different from a material of a conductive layer of the endmost coil wiring.
